(19) United States
(12) Patent Application Publication
(10) Pub. No.: US 2014/0237038 A1
(43) Pub. Date: Aug. 21, 2014

(54) Method and Apparatus for Determining an Activity Description

(71) Applicant: NOKIA CORPORATION, Espoo (FI)

(72) Inventors: John-Rhys Newman, Woodland Hills, CA (US); Duncan Burns, Santa Monica, CA (US); Vidyut Samanta, Santa Monica, CA (US); Sebastian Frey, Woodland Hills, CA (US); Pascal Wever, Los Angeles, CA (US); Julian Bleeker, Los Angeles, CA (US); Jeffrey Alan Kessler, Palo Alto, CA (US)

(73) Assignee: Nokia Corporation, Espoo (FI)

(21) Appl. No.: 13/768,914

(22) Filed: Feb. 15, 2013

(51) Int. Cl. H04L 12/58

(52) U.S. Cl. CPC H04L 51/32
USPC 709/204

(57) ABSTRACT

A method comprising receiving a sensor dependent information associated with an activity of a user, determining an activity description based, at least in part, on the sensor dependent information and a description terminology information, and causing communication of the activity description is disclosed.

### TECHNICAL FIELD

The present application relates generally to determining an activity description.

### BACKGROUND

As electronic apparatuses have expanded their capabilities, as well as the number and types of operations they perform, interaction has become increasingly complex and time consuming. For example, apparatus interaction may be prone to errors, confusion, and delay. In some circumstances, a user may miss an opportunity to do something, such as capture an image of an event, due to delays associated with interaction. In other circumstances, a user may avoid utilizing an apparatus capability due to a desire to avoid errors, confusion, or delay. These problems may be more pronounced with regard to a user communicating an activity that the user is performing. It may be desirable to allow a user to communicate an activity that the user is performing without the user performing an inconvenient series of operations.

### SUMMARY

Various aspects of examples of the invention are set out in the claims.

One or more embodiments may provide an apparatus, a computer readable medium, a non-transitory computer readable medium, and a method for receiving a sensor dependent information associated with an activity of a user, determining an activity description based, at least in part, on the sensor dependent information and a description terminology information, and causing communication of the activity description.

In at least one example embodiment, the sensor dependent information comprises sensor information and sensor interpretation information

In at least one example embodiment, the sensor dependent information relates to motion information and position information.

In at least one example embodiment, the description terminology information relates to information that is independent of sensor information and independent of sensor interpretation information.

In at least one example embodiment, the description terminology information relates to sensor independent information that is distinct from information utilized to convert a description to a translated description.

In at least one example embodiment, the description terminology information relates to information associated with a user expressive style.

In at least one example embodiment, the determination of the activity description is based, at least in part, on historical description terminology information.

In at least one example embodiment, the determination of the activity description is performed absent user determination of the activity description.

In at least one example embodiment, the determination of the activity description is further based, at least in part, on at least one terminology propensity setting.

In at least one example embodiment, the terminology propensity setting is indicative of at least one categorization of the description terminology information.

In at least one example embodiment, causation of communication of the activity description comprises sending the activity description to another apparatus.

In at least one example embodiment, causing communication of the activity description comprises appending the activity description as a signature line of a message.

One or more example embodiments further cause determining an interpreted activity based, at least in part, on the sensor dependent information, wherein the determination of the activity description is based, at least in part, on the interpreted activity.

In at least one example embodiment, the activity description comprises an action description and a location description.

In at least one example embodiment, determining the activity description comprises determining the action description based, based, at least in part, on the sensor dependent information and a description terminology information.

In at least one example embodiment, determining the activity description comprises determining the location description based, based, at least in part, on the sensor dependent information and a description terminology information.

One or more embodiments may provide an apparatus, a computer readable medium, a non-transitory computer readable medium, and a method for receiving a sensor dependent information associated with an activity of a user, receiving an apparatus mounting information, determining an activity description based, at least in part, on the sensor dependent information, the apparatus mounting information, and a description terminology information, and causing communication of the activity description.

In at least one example embodiment, the apparatus mounting information relates to an identification of a mount apparatus to which the apparatus is mounted, and wherein the determination of the activity description is based, at least in part, on the identification of the mount apparatus.

In at least one example embodiment, the apparatus mounting information relates to an identification of an activity classification associated with a mount apparatus to which the apparatus is mounted, and wherein the determination of the activity description is based, at least in part, on the activity classification.

In at least one example embodiment, determination of the activity description is based, at least in part, on description terminology information associated with the activity classification.

In at least one example embodiment, determination of the activity description is based, at least in part, on description terminology information indicative of a jargon associated with the activity classification.

In at least one example embodiment, the apparatus mounting information relates to an identification of a sport associated with the mount apparatus, and wherein the determination of the activity description is based, at least in part, on the identification of the sport.

In at least one example embodiment, the description terminology information comprises at least one categorization associated with the apparatus mounting information.

One or more example embodiments further cause receiving of mounting description terminology information, wherein the description terminology information comprises the mounting description terminology information.

One or more example embodiments further cause supplementing of the description terminology information with the mounting description terminology information.

In at least one example embodiment, the determination of the activity description is further based, at least in part, on at least one mount terminology propensity setting.

In at least one example embodiment, the sensor dependent information comprises sensor information and sensor interpretation information.

In at least one example embodiment, the sensor dependent information relates to motion information and position information.

In at least one example embodiment, the description terminology information relates to information that is independent of sensor information and independent of sensor interpretation information.

In at least one example embodiment, the description terminology information relates to sensor independent information that is distinct from information utilized to convert a description to a translated description.

In at least one example embodiment, the description terminology information relates to information associated with a user expressive style.

In at least one example embodiment, the description terminology information comprises historical description terminology information.

In at least one example embodiment, the determination of the activity description is performed absent user determination of the activity description.

In at least one example embodiment, the determination of the activity description is further based, at least in part, on at least one terminology propensity setting that is independent of a mount terminology propensity setting.

In at least one example embodiment, the terminology propensity setting is indicative of at least one categorization of the description terminology information that is independent of the mount information.

In at least one example embodiment, causation of communication of the activity description comprises sending the activity description to another apparatus.

In at least one example embodiment, causing communication of the activity description comprises appending the activity description as a signature line of a message.

One or more example embodiments further cause determining of an interpreted activity based, at least in part, on the sensor dependent information, wherein the determination of the activity description is based, at least in part, on the interpreted activity.

In at least one example embodiment, the activity description comprises an action description and a location description.

In at least one example embodiment, determining the activity description comprises determining the action description based, at least in part, on the sensor dependent information and a description terminology information.

In at least one example embodiment, determining the activity description comprises determining the location description based, at least in part, on the sensor dependent information and a description terminology information.

One or more embodiments may provide an apparatus, a computer readable medium, a non-transitory computer readable medium, and a method for receiving a sensor dependent information associated with an activity of a user, determining an activity description based, at least in part, on the sensor dependent information, a description terminology information, and a seriousness level identifier, at least part of the description terminology information being associated with a seriousness level associated with the seriousness level identifier, and causing communication of the activity description.

In at least one example embodiment, the seriousness level relates to a seriousness threshold.

In at least one example embodiment, the determination of the activity description based, at least in part, on the seriousness level identifier relates to exclusion of description terminology information relating to a seriousness level less than the seriousness threshold.

In at least one example embodiment, the seriousness level relates to a seriousness preference.

In at least one example embodiment, the determination of the activity description based, at least in part, on the seriousness level identifier relates to selection of description terminology information based, at least in part, on proximity to the seriousness preference.

In at least one example embodiment, the seriousness level identifier is based, at least in part on a user setting.

In at least one example embodiment, the seriousness level identifier is based, at least in part, on recipient information.

In at least one example embodiment, causation of the communication of the activity description comprises causation of communication of the activity description to the recipient.

In at least one example embodiment, sensor dependent information comprises sensor information and sensor interpretation information.

In at least one example embodiment, the sensor dependent information relates to motion information and position information.

In at least one example embodiment, the description terminology information relates to information that is independent of sensor information and independent of sensor interpretation information.

In at least one example embodiment, the description terminology information relates to sensor independent information that is distinct from information utilized to convert a description to a translated description.

In at least one example embodiment, the determination of the activity description is performed absent user determination of the activity description.

In at least one example embodiment, the determination of the activity description is further based, at least in part, on at least one terminology propensity setting that is independent of the seriousness level.

In at least one example embodiment, the terminology propensity setting is indicative of at least one categorization of the description terminology information that is independent of the seriousness level.

In at least one example embodiment, causation of communication of the activity description comprises sending the activity description to another apparatus.

In at least one example embodiment, causing communication of the activity description comprises appending the activity description as a signature line of a message.

In at least one example embodiment, comprising determining an interpreted activity based, at least in part, on the sensor dependent information, wherein the determination of the activity description is based, at least in part, on the interpreted activity.

In at least one example embodiment, the activity description comprises an action description and a location description.

In at least one example embodiment, determining the activity description comprises determining the action description based, at least in part, on the sensor dependent information, the description terminology information, and the seriousness level identifier.

In at least one example embodiment, determining the activity description comprises determining the location description based, at least in part, on the sensor dependent information, the description terminology information, and the seriousness level identifier.

In at least one example embodiment, the description terminology information comprises historical description terminology information.

In at least one example embodiment, the determination of the activity description is further based, at least in part, on an apparatus mounting information.

One or more embodiments may provide an apparatus, a computer readable medium, a non-transitory computer readable medium, and a method for receiving a sensor dependent information associated with an activity of a user, determining an activity description based, at least in part, on the sensor dependent information, a description terminology information, and a specificity level identifier, at least part of the description terminology information being associated with a specificity level associated with the specificity level identifier, and causing communication of the activity description.

In at least one example embodiment, the specificity level relates to a specificity threshold.

In at least one example embodiment, the determination of the activity description based, at least in part, on the specificity level identifier relates to exclusion of description terminology information relating to a specificity level less than the specificity threshold.

In at least one example embodiment, the specificity level relates to a specificity preference.

In at least one example embodiment, the determination of the activity description based, at least in part, on the specificity level identifier relates to selection of description terminology information based, at least in part, on proximity to the specificity preference.

In at least one example embodiment, the specificity level identifier is based, at least in part on a user setting.

In at least one example embodiment, the specificity level identifier is based, at least in part, on recipient information.

In at least one example embodiment, causation of the communication of the activity description comprises causation of communication of the activity description to the recipient.

In at least one example embodiment, sensor dependent information comprises sensor information and sensor interpretation information.

In at least one example embodiment, the sensor dependent information relates to motion information and position information.

In at least one example embodiment, the description terminology information relates to information that is independent of sensor information and independent of sensor interpretation information.

In at least one example embodiment, the description terminology information relates to sensor independent information that is distinct from information utilized to convert a description to a translated description.

In at least one example embodiment, the determination of the activity description is performed absent user determination of the activity description.

In at least one example embodiment, the determination of the activity description is further based, at least in part, on at least one terminology propensity setting that is independent of the specificity level.

In at least one example embodiment, the terminology propensity setting is indicative of at least one categorization of the description terminology information that is independent of the specificity level.

In at least one example embodiment, causation of communication of the activity description comprises sending the activity description to another apparatus.

In at least one example embodiment, causing communication of the activity description comprises appending the activity description as a signature line of a message.

One or more example embodiments further cause determining of an interpreted activity based, at least in part, on the sensor dependent information, wherein the determination of the activity description is based, at least in part, on the interpreted activity.

In at least one example embodiment, the activity description comprises an action description and a location description.

In at least one example embodiment, determining the activity description comprises determining the action description based, at least in part, on the sensor dependent information, the description terminology information, and the specificity level identifier.

In at least one example embodiment, determining the activity description comprises determining the location description based, at least in part, on the sensor dependent information, the description terminology information, and the specificity level identifier.

In at least one example embodiment, the description terminology information comprises historical description terminology information.

In at least one example embodiment, the determination of the activity description is further based, at least in part, on an apparatus mounting information.

In at least one example embodiment, the specificity level identifier relates to at least one privacy setting.

In at least one example embodiment, the specificity level identifier comprises at least one of an action specificity level identifier or a location specificity level identifier.

In at least one example embodiment, the specificity level identifier comprises the action specificity level identifier, and wherein determination of the activity description comprises determination of an action description based, at least in part, on the sensor dependent information, the description terminology information, and the action specificity level identifier.

In at least one example embodiment, the specificity level identifier comprises the location specificity level identifier, and wherein determination of the activity description comprises determination of a location description based, at least in part, on the sensor dependent information, the description terminology information, and the location specificity level identifier.

In at least one example embodiment, the specificity level identifier comprises the action specificity level identifier and the location specificity identifier, wherein determination of the activity description comprises determination of an action description based, at least in part, on the sensor dependent information, the description terminology information, and the action specificity level identifier, and wherein determination of the activity description comprises determination of a location description based, at least in part, on the sensor dependent information, the description terminology information, and the location specificity level identifier.

One or more embodiments may provide an apparatus, a computer readable medium, a non-transitory computer readable medium, and a method for receiving a sensor dependent information associated with an activity of a user, determining an activity description based, at least in part, on the sensor dependent information and a description terminology information, determining a historically supplemented activity description based, at least in part, on the activity description, a historical description terminology information, historical activity information; and causing communication of the historically supplemented activity description.

In at least one example embodiment, the historically supplemented activity description comprises the activity description and additional description information indicative of, at least part of, the historical activity information.

In at least one example embodiment, determination of the historically supplemented activity description is further based, at least in part, on a historical terminology propensity setting.

In at least one example embodiment, the historical description terminology information comprises terminology indicative of a previous communication regarding, at least part of, the activity description.

In at least one example embodiment, the historical description terminology information comprises terminology indicative of deviation from previous user activity.

In at least one example embodiment, the historical description terminology information comprises terminology indicative of a previously determined activity description.

In at least one example embodiment, the previously determined activity description is associated with the activity description.

In at least one example embodiment, the historical description terminology information is indicative of a previous communication regarding, at least part of, the activity description.

In at least one example embodiment, the historical activity information is indicative of deviation from previous user activity.

In at least one example embodiment, the historical activity information is indicative of a previously determined activity description.

In at least one example embodiment, the previously determined activity description is associated with the activity description.

In at least one example embodiment, comprising causing supplementation of the historical activity information with information indicative of the activity description.

In at least one example embodiment, sensor dependent information comprises sensor information and sensor interpretation information.

In at least one example embodiment, the sensor dependent information relates to motion information and position information.

In at least one example embodiment, the description terminology information relates to information that is independent of sensor information and independent of sensor interpretation information.

In at least one example embodiment, the description terminology information relates to sensor independent information that is distinct from information utilized to convert a description to a translated.

In at least one example embodiment, the description terminology information relates to information associated with a user expressive style.

In at least one example embodiment, the determination of the activity description is performed absent user determination of the activity description.

In at least one example embodiment, the determination of the activity description is further based, at least in part, on at least one terminology propensity setting independent of a historical terminology propensity setting.

In at least one example embodiment, the terminology propensity setting is indicative of at least one categorization of the description terminology information independent of the historical description terminology information.

In at least one example embodiment, causation of communication of the activity description comprises sending the activity description to another apparatus.

In at least one example embodiment, causing communication of the activity description comprises appending the activity description as a signature line of a message.

One or more example embodiments further cause determining of an interpreted activity based, at least in part, on the sensor dependent information, wherein the determination of the activity description is based, at least in part, on the interpreted activity.

In at least one example embodiment, the activity description comprises an action description and a location description.

In at least one example embodiment, determining the activity description comprises determining the action description based, at least in part, on the sensor dependent information and a description terminology information.

In at least one example embodiment, determining the activity description comprises determining the location description based, at least in part, on the sensor dependent information and a description terminology information.

### BRIEF DESCRIPTION OF THE DRAWINGS

For a more complete understanding of embodiments of the invention, reference is now made to the following descriptions taken in connection with the accompanying drawings in which:

FIG. 1 is a block diagram showing an apparatus, such as an electronic apparatus 10, according to an example embodiment;

FIGS. 2A-2I is a diagram illustrating information associated with determination of an activity description according to at least one example embodiment

FIGS. 3A-3G are diagrams illustrating information associated with determination of an activity description according to at least one example embodiment;

FIG. 4 is a flow diagram illustrating activities associated with determining an activity description according to at least one example embodiment;

FIG. 5 is a flow diagram illustrating activities associated with determining an activity description according to at least one example embodiment;

FIG. 6 is a flow diagram illustrating activities associated with determining an activity description according to at least one example embodiment;

FIG. 7 is a flow diagram illustrating activities associated with determining an activity description according to at least one example embodiment;

FIG. 8 is a flow diagram illustrating activities associated with determining an activity description according to at least one example embodiment;

FIG. 9 is a flow diagram illustrating activities associated with determining an activity description according to at least one example embodiment;

FIG. 10 is a flow diagram illustrating activities associated with determining an activity description according to at least one example embodiment;

FIG. 11 is a flow diagram illustrating activities associated with determining an activity description according to at least one example embodiment;

FIG. 12 is a flow diagram illustrating activities associated with determining an activity description according to at least one example embodiment;

FIG. 13 is a flow diagram illustrating activities associated with determining an activity description according to at least one example embodiment;

FIG. 14 is a flow diagram illustrating activities associated with determining an activity description according to at least one example embodiment;

FIG. 15 is a flow diagram illustrating activities associated with determining an activity description according to at least one example embodiment;

FIG. 16 is a flow diagram illustrating activities associated with determining an activity description according to at least one example embodiment;

FIG. 17 is a flow diagram illustrating activities associated with determining an activity description according to at least one example embodiment;

FIG. 18 is a flow diagram illustrating activities associated with determining an activity description according to at least one example embodiment;

FIG. 19 is a flow diagram illustrating activities associated with determining an activity description according to at least one example embodiment;

FIG. 20 is a flow diagram illustrating activities associated with determining an activity description according to at least one example embodiment;

FIG. 21 is a flow diagram illustrating activities associated with determining an activity description according to at least one example embodiment;

FIG. 22 is a flow diagram illustrating activities associated with determining an activity description according to at least one example embodiment;

FIG. 23 is a flow diagram illustrating activities associated with determining an activity description according to at least one example embodiment;

FIG. 24 is a flow diagram illustrating activities associated with determining an activity description according to at least one example embodiment;

FIG. 25 is a flow diagram illustrating activities associated with determining an activity description according to at least one example embodiment;

FIG. 26 is a flow diagram illustrating activities associated with determining an activity description according to at least one example embodiment; and

FIG. 27 is a flow diagram illustrating activities associated with determining an activity description according to at least one example embodiment.

### DETAILED DESCRIPTION OF THE DRAWINGS

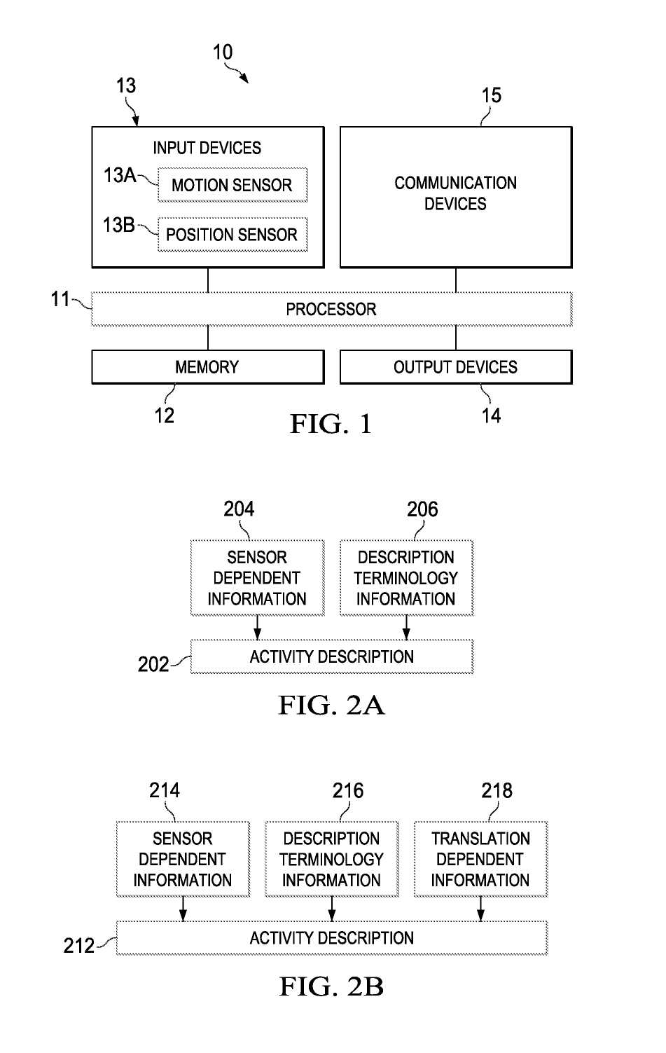

An embodiment of the invention and its potential advantages are understood by referring to FIGS. 1 through 27 of the drawings.

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “non-transitory computer-readable medium,” which refers to a physical medium (e.g., volatile or non-volatile memory device), can be differentiated from a “transitory computer-readable medium,” which refers to an electromagnetic signal.

As users use their electronic apparatuses for an increasing percentage of their communications with other people, a user's expressive style in communication becomes increasingly desirable. For example, two users may communicate the same content in very different ways. For example, regarding the same activity, one user may communicate in a very clinical manner, without any embellishment, and another user may be very descriptive, provide context regarding significance of the activities, and possibly even provide a level of whimsy. The level of expressiveness may greatly vary the perception of the content being communicated. For example, a recipient may interpret a clinical statement that is absent expressivity as impersonal and unengaged. In another example, a recipient may interpret an expressive detailed and whimsical statement to be inappropriate and overly personal. The desirability of managing expressive style in communications becomes increasingly desirable regarding automatically generated communication. For example, a recipient may interpret an automatically generated communication that differs from the sender's normal expressive style in a very different way than an automatically generated communication that resembles the sender's expressive style. However, it may be further desirable that such automatically generated communications provide an appropriate level of expressive style, as described above.

Furthermore, as social networking has become more prevalent, many users have relationships with other people that is solely based, at least in part, on communications by way of an electronic device. For example, an increasing number of users have relationships with people that they have never physically met. In such circumstances, expressive style may be critical to establishing or maintaining such relationships.

In addition, automatically generated communications are becoming increasingly desirable as users share an increasing amount of information with others by way of their electronic apparatuses. For example, users are sharing an increasing amount of information regarding their activities throughout the day. In some circumstances, users desire to keep others informed of even small changes in activities throughout their day. This type of manual updating of information may become tedious and/or time consuming. Therefore, it may be desirable for some users to have communications regarding their activities automatically generated.

FIG. 1 is a block diagram showing an apparatus, such as an electronic apparatus 10, according to an example embodiment. It should be understood, however, that an electronic apparatus as illustrated and hereinafter described is merely illustrative of an electronic apparatus that could benefit from embodiments of the invention and, therefore, should not be taken to limit the scope of the invention. While electronic apparatus 10 is illustrated and will be hereinafter described for purposes of example, other types of electronic apparatuses, may readily employ embodiments of the invention. Electronic apparatus 10 may be a portable digital assistant (PDAs), a pager, a mobile computer, a desktop computer, a television, a gaming apparatus, a laptop computer, a media player, a camera, a video recorder, a mobile phone, a global positioning system (GPS) apparatus, and/or any other types of electronic systems. Moreover, the apparatus of an example embodiment need not be the entire electronic apparatus, but may be a component or group of components of the electronic apparatus in other example embodiments.

Furthermore, apparatuses may readily employ embodiments of the invention regardless of their intent to provide mobility. In this regard, even though embodiments of the invention may be described in conjunction with mobile applications, it should be understood that embodiments of the invention may be utilized in conjunction with a variety of other applications, both in the mobile communications industries and outside of the mobile communications industries.

In at least one example embodiment, electronic apparatus 10 comprises processor 11 and memory 12. Processor 11 may be any type of processor, controller, embedded controller, processor core, and/or the like. In at least one example embodiment, processor 11 utilizes computer program code to cause an apparatus to perform one or more actions. Memory 12 may comprise volatile memory, such as volatile Random Access Memory (RAM) including a cache area for the temporary storage of data and/or other memory, for example, non-volatile memory, which may be embedded and/or may be removable. The non-volatile memory may comprise an EEPROM, flash memory and/or the like. Memory 12 may store any of a number of pieces of information, and data. The information and data may be used by the electronic apparatus 10 to implement one or more functions of the electronic apparatus 10, such as the functions described herein. In at least one example embodiment, memory 12 includes computer program code such that the memory and the computer program code are configured to, working with the processor, cause the apparatus to perform one or more actions described herein.

The electronic apparatus 10 may further comprise a communication device 15. In at least one example embodiment, communication device 15 comprises an antenna, (or multiple antennae), a wired connector, and/or the like in operable communication with a transmitter and/or a receiver. In at least one example embodiment, processor 11 provides signals to a transmitter and/or receives signals from a receiver. The signals may comprise signaling information in accordance with a communications interface standard, user speech, received data, user generated data, and/or the like. Communication device 15 may operate with one or more air interface standards, communication protocols, modulation types, and access types. By way of illustration, the electronic communication device 15 may operate in accordance with second-generation (2G) wireless communication protocols IS-136 (time division multiple access (TDMA)), Global System for Mobile communications (GSM), and IS-95 (code division multiple access (CDMA)), with third-generation (3G) wireless communication protocols, such as Universal Mobile Telecommunications System (UMTS), CDMA2000, wideband CDMA (WCDMA) and time division-synchronous CDMA (TD-SCDMA), and/or with fourth-generation (4G) wireless communication protocols, wireless networking protocols, such as 802.11, short-range wireless protocols, such as Bluetooth, and/or the like. Communication device 15 may operate in accordance with wireline protocols, such as Ethernet, digital subscriber line (DSL), asynchronous transfer mode (ATM), and/or the like.

Processor 11 may comprise means, such as circuitry, for implementing audio, video, communication, navigation, logic functions, and/or the like, as well as for implementing embodiments of the invention including, for example, one or more of the functions described herein. For example, processor 11 may comprise means, such as a digital signal processor device, a microprocessor device, various analog to digital converters, digital to analog converters, processing circuitry and other support circuits, for performing various functions including, for example, one or more of the functions described herein. The apparatus may perform control and signal processing functions of the electronic apparatus 10 among these devices according to their respective capabilities. The processor 11 thus may comprise the functionality to encode and interleave message and data prior to modulation and transmission. The processor 1 may additionally comprise an internal voice coder, and may comprise an internal data modem. Further, the processor 11 may comprise functionality to operate one or more software programs, which may be stored in memory and which may, among other things, cause the processor 11 to implement at least one embodiment including, for example, one or more of the functions described herein. For example, the processor 11 may operate a connectivity program, such as a conventional internet browser. The connectivity program may allow the electronic apparatus 10 to transmit and receive internet content, such as location-based content and/or other web page content, according to a Transmission Control Protocol (TCP), Internet Protocol (IP), User Datagram Protocol (UDP), Internet Message Access Protocol (IMAP), Post Office Protocol (POP), Simple Mail Transfer Protocol (SMTP), Wireless Application Protocol (WAP), Hypertext Transfer Protocol (HTTP), and/or the like, for example.

The electronic apparatus 10 may comprise a user interface for providing output and/or receiving input. The electronic apparatus 10 may comprise output devices 14. In at least one example embodiment, output devices 14 comprise one or more output devices. Output devices 14 may comprise an audio output device, such as a ringer, an earphone, a speaker, and/or the like. Output devices 14 may comprise a tactile output device, such as a vibration transducer, an electronically deformable surface, an electronically deformable structure, and/or the like. Output devices 14 may comprise a visual output device, such as a display, a light, and/or the like. The electronic apparatus may comprise input devices 13. In at least one example embodiment, input devices 13 comprise one or more input devices. Input devices 13 may comprise a light sensor, a proximity sensor, a microphone, a touch sensor, a force sensor, a button, a keypad, a motion sensor, a magnetic field sensor, a camera, and/or the like. A touch sensor and a display may be characterized as a touch display. In an embodiment comprising a touch display, the touch display may be configured to receive input from a single point of contact, multiple points of contact, and/or the like. In such an embodiment, the touch display and/or the processor may determine input based, at least in part, on position, motion, speed, contact area, and/or the like.

The electronic apparatus 10 may include any of a variety of touch displays including those that are configured to enable touch recognition by any of resistive, capacitive, infrared, strain gauge, surface wave, optical imaging, dispersive signal technology, acoustic pulse recognition or other techniques, and to then provide signals indicative of the location and other parameters associated with the touch. Additionally, the touch display may be configured to receive an indication of an input in the form of a touch event which may be defined as an actual physical contact between a selection object (e.g., a finger, stylus, pen, pencil, or other pointing device) and the touch display. Alternatively, a touch event may be defined as bringing the selection object in proximity to the touch display, hovering over a displayed object or approaching an object within a predefined distance, even though physical contact is not made with the touch display. As such, a touch input may comprise any input that is detected by a touch display including touch events that involve actual physical contact and touch events that do not involve physical contact but that are otherwise detected by the touch display, such as a result of the proximity of the selection object to the touch display. A touch display may be capable of receiving information associated with force applied to the touch screen in relation to the touch input. For example, the touch screen may differentiate between a heavy press touch input and a light press touch input. In at least one example embodiment, a display may display two-dimensional information, three-dimensional information and/or the like.

In embodiments including a keypad, the keypad may comprise numeric (for example, 0-9) keys, symbol keys (for example, #, *), alphabetic keys, and/or the like for operating the electronic apparatus 10. For example, the keypad may comprise a conventional QWERTY keypad arrangement. The keypad may also comprise various soft keys with associated functions. In addition, or alternatively, the electronic apparatus 10 may comprise an interface device such as a joystick or other user input interface.

Input devices 13 may comprise a media capturing element. The media capturing element may be any means for capturing an image, video and/or audio for storage, display or transmission. For example, in an example embodiment in which the media capturing element is a camera module, the camera module may comprise a digital camera which may form a digital image file from a captured image. As such, the camera module may comprise hardware, such as a lens or other optical component(s), and/or software necessary for creating a digital image file from a captured image. Alternatively, the camera module may comprise only the hardware for viewing an image, while a memory device of the electronic apparatus 10 stores instructions for execution by the processor 11 in the form of software for creating a digital image file from a captured image. In an example embodiment, the camera module may further comprise a processing element such as a co-processor that assists the processor 11 in processing image data and an encoder and/or decoder for compressing and/or decompressing image data. The encoder and/or decoder may encode and/or decode according to a standard format, for example, a Joint Photographic Experts Group (JPEG) standard format.

In at least one example embodiment, input devices 13 comprises at least one motion sensor, such as motion sensor 13A. A motion sensor may relate to any sensor that may provide information indicating at least one aspect associated with motion. For example, a motion sensor may relate to an accelerometer, an orientation sensor. In at least one example embodiment, a motion sensor provides information indicating motion of apparatus 10, such as movement being performed by a user regarding apparatus 10.

In at least one example embodiment, input devices 13 comprises at least one position sensor, such as position sensor 13B. A position sensor may relate to any sensor associated with determining a position of the apparatus. For example, a position sensor may relate to a global positioning system (GPS) sensor and/or any other circuit and/or software that provides information indicative of a position of the apparatus. The position may relate to a geographical position.

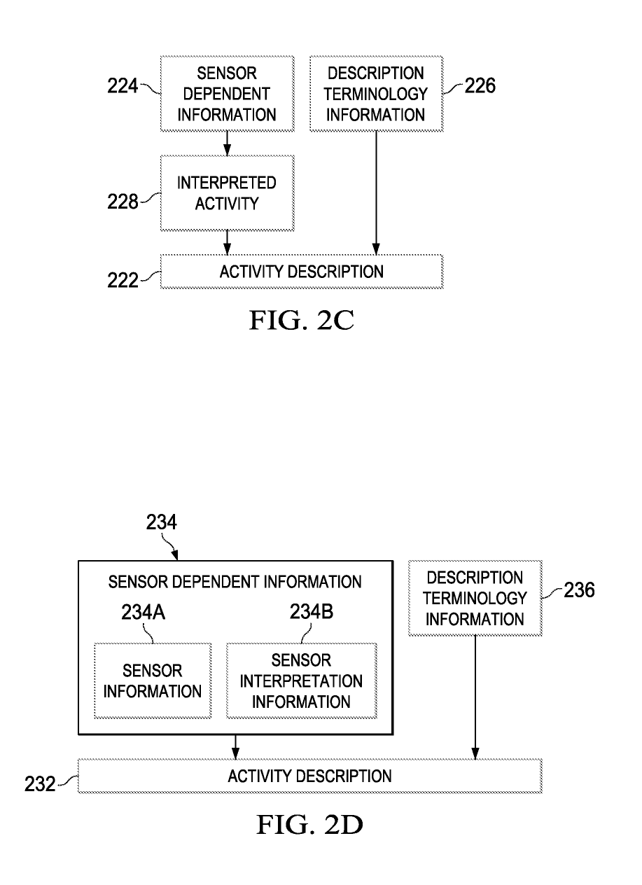

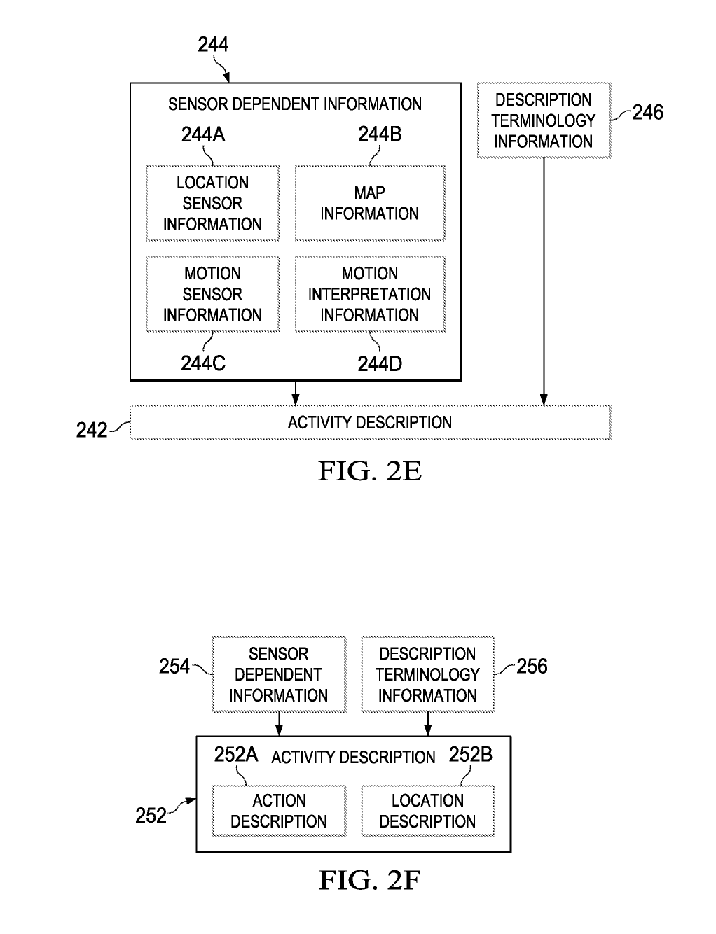

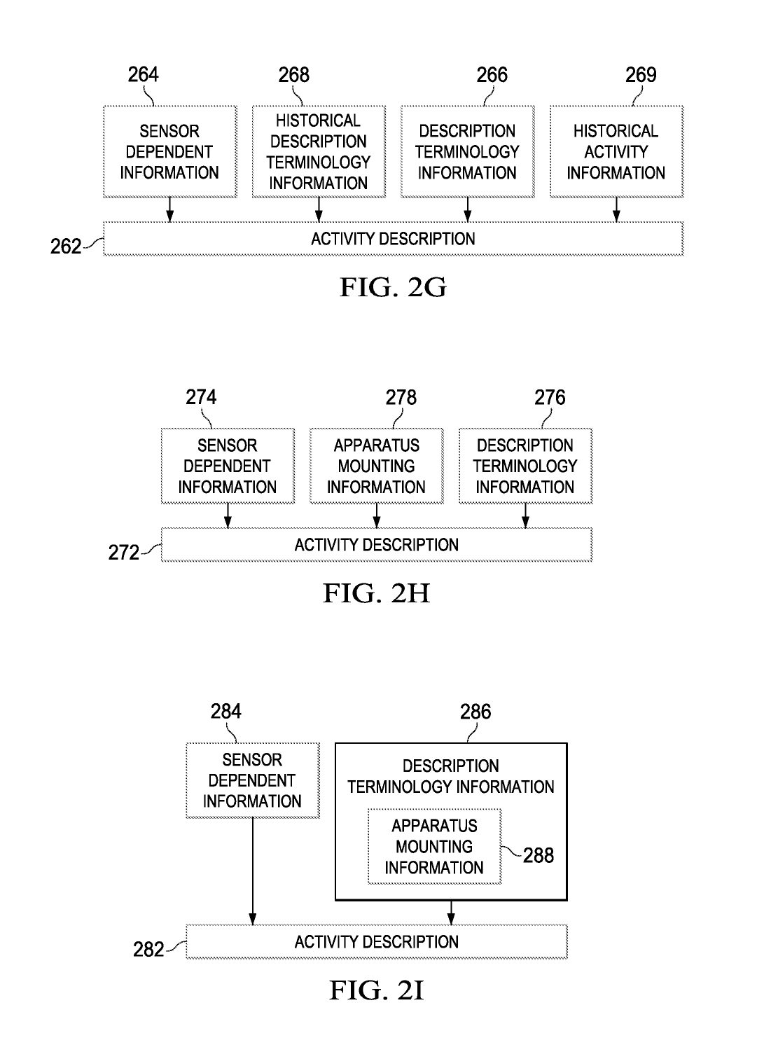

FIGS. 2A-2I are diagrams illustrating information associated with determination of an activity description according to at least one example embodiment. The example of FIG. 2A-2I is merely an example of information associated with determination of an activity description, and does not limit the scope of the claims. For example, types of information may vary, a relationship between information may vary, and/or the like.

There has been an increasing trend among users to share many aspects of their lives with others. For example, users often communicate with others regarding activities that the users are performing, about thoughts that the users are having, about people that the users are associating with, etc. In such an example, users may provide such information by way of social networking sites, for example by way of posting the information, by way of messaging, for example text messaging, email, instant messaging, etc. As this type of communication becomes more prevalent, it may be desirable to reduce the amount of time a user spends providing such information. For example, a user may desire to have information regarding an activity that the user is performing automatically determined and communicated.

In at least one example embodiment, an apparatus automatically determines an activity of a user such that the apparatus may cause communication of an activity description associated with the activity being performed by the user. For example, the apparatus may cause sending of the activity description to another apparatus, such as sending by way of at least part of communication devices 15 of FIG. 1. For example, the apparatus may cause sending of the activity description by causing sending of an email to an email server, by causing posting of the activity description in association with a social network server, by causing sending of a text message, by causing sending of an instant message, and/or the like. In at least one example embodiment, such communication may be for the purpose of communicating the activity description. In such an example, the communication may be caused by determination of the activity description. In at least one example embodiment, such communication may be for the purpose of supplementing a communication. In such an example, the activity description may be comprised as a part, which is less than the entirety, of the content of a communication. For example, the activity description may be comprised in a signature line of a message. In at least one example embodiment, a signature line of a message relates to information that is appended to message content such that the message recipient receives the signature line in conjunction with the message content.

FIG. 2A is a diagram illustrating information associated with determination of an activity description according to at least one example embodiment. In at least one example embodiment, an apparatus determines an activity description based, at least in part, on sensor dependent information and description terminology information. In the example of FIG. 2A, activity description 202 may be based, at least in part, on sensor dependent information 204 and description terminology information 206.

In at least one example embodiment, an activity description relates to a descriptive representation of an activity that the device has determined to be performed by the user. The descriptive representation may be a textual descriptive representation, a visual descriptive representation, and/or the like. In at least one example embodiment, a visual descriptive representation comprises visual information that is independent of any captured visual information associated with performance of the activity. For example, the visual information may be an animation, avatar instructions, and/or the like, that is independent of any captured visual information, such as an image of the user performing the activity. In at least one example embodiment, an activity description is a language-based activity description. In at least one example embodiment, a language-based activity description relates to a representation of an activity that utilizes a language to characterize the represented activity. For example, a language-based activity may be a textual representation comprising one or more words, an audible representation comprising an audible signal indicative of one or more words, and/or the like.

In at least one example embodiment, sensor dependent information relates to information associated with detecting and evaluating at least one aspect of a user activity. Sensor dependent information may be similar as described regarding FIGS. 2C-2E.

In at least one example embodiment, description terminology information relates to information associated with determination of how to represent an activity by way of the activity description. In at least one example embodiment, the description terminology information relates to information that is distinct from the activity description. For example, the description terminology information may comprise terms that were precluded from the activity description. In at least one example embodiment, the description terminology information is independent of the sensor dependent information. For example, the description terminology information may be a separate data structure, may be received from a different source, and/or the like, from the sensor dependent information.

In at least one example embodiment, the apparatus determines the activity description based, at least in part, on an activity indicated by the sensor dependent information, such as sensor dependent information 204. For example, the sensor dependent information may indicate that a user is shopping at a grocery store, dancing at a night club, walking down the street, working at the office, climbing up a mountain, and/or the like.

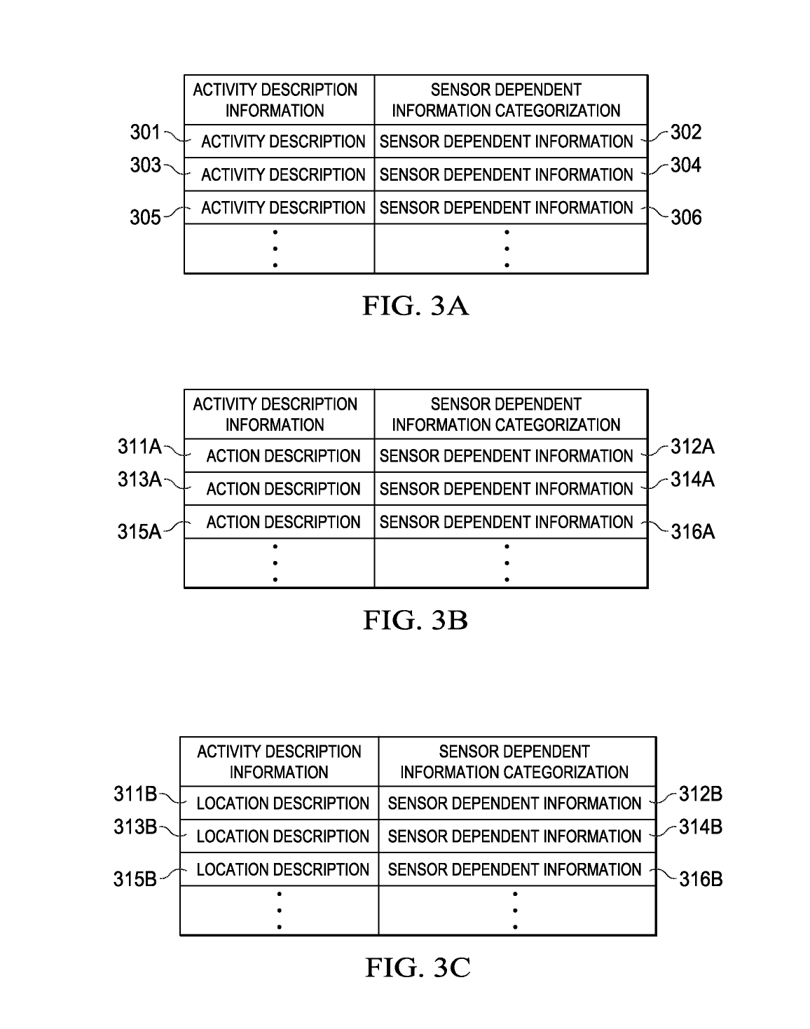

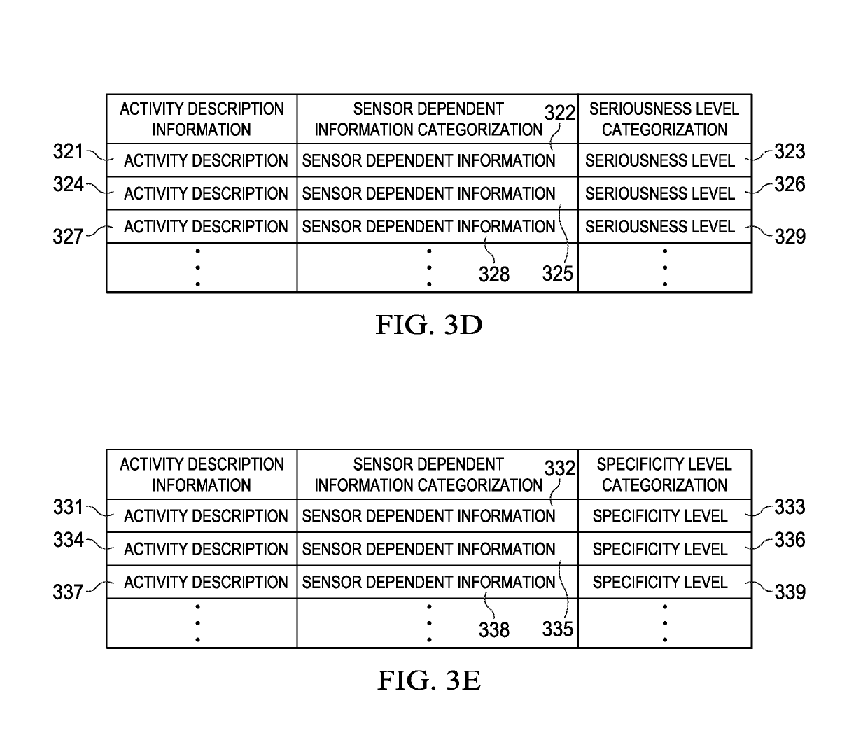

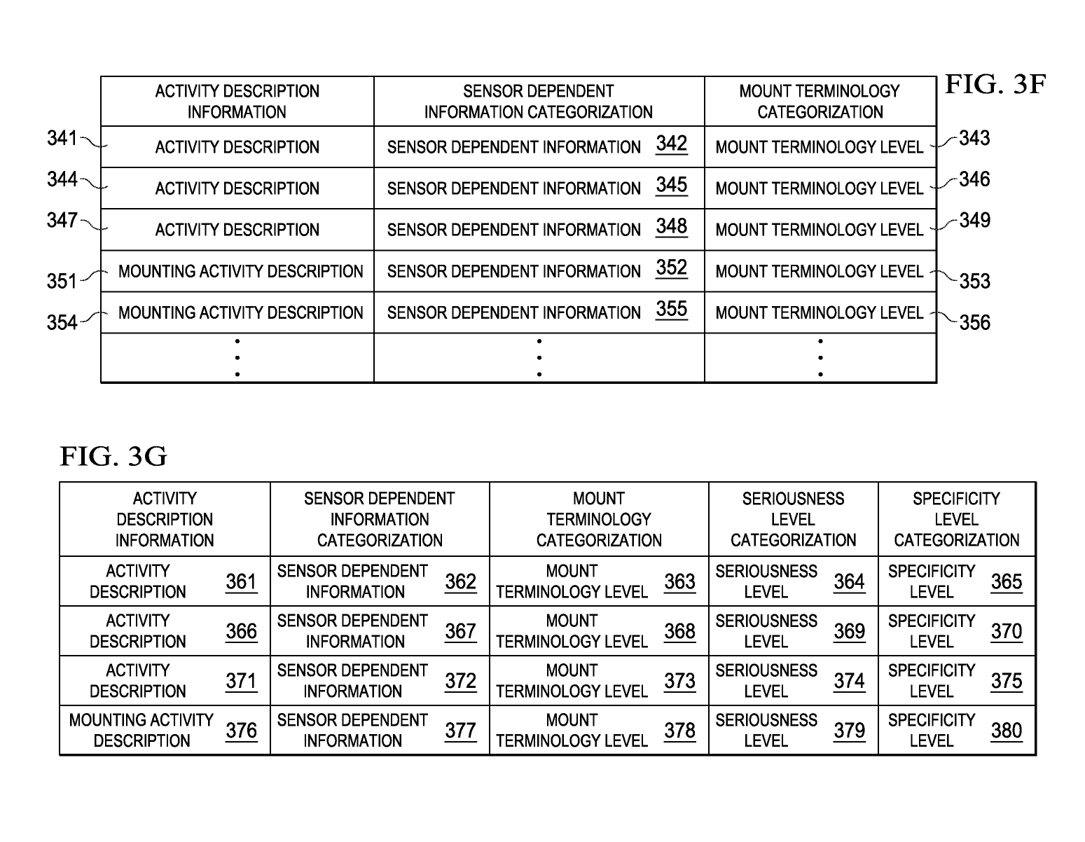

In at least one example embodiment, the apparatus correlates an activity indicated by the sensor dependent information with, at least part of the description terminology information to determine the activity description. For example, the apparatus may utilize the description terminology information to determine how to describe an activity indicated by the sensor dependent information. In such an example, the description terminology may comprise a plurality of descriptions that may be applicable to an activity indicated by the sensor dependent information. Under such circumstances, the apparatus may select one or more descriptions comprised by the description terminology information for inclusion in the activity description. Such determination may be similar as described regarding FIG. 2I and FIGS. 3A-3G.

In at least one example embodiment, a user may determine one or more terms comprised in an activity description. For example, the apparatus may allow a user to alter one or more parts of an activity description. Such alteration may result in user determination of, at least part of, the activity description. In at least one example embodiment, at least one part of the activity description that is indicative of the user activity is determined absent user determination. In such an embodiment, less than all of the activity description is associated with a user determination. In at least one example embodiment, information associated with a previous user determination may be utilized in determination of the activity description. However, such utilization may relate to historical description terminology information, similar as described regarding FIG. 2G, may relate to a modification of description terminology information based, at least in part, on the previous user selection, and/or the like. In at least one example embodiment, such utilization of previous user determination relates to determination of the activity description absent user determination, for at least the reason that the user determination is related to a different determination of an activity description.

In at least one example embodiment, determination of the activity description may be performed absent user determination of the activity description. For example, the activity description may be determined absent user selection any of terms to be included in and/or precluded from the activity description.

FIG. 2B is a diagram illustrating information associated with determination of an activity description according to at least one example embodiment. In the example of FIG. 2B, activity description 212 may be based, at least in part, on sensor dependent information 214, description terminology information 216, and translation dependent information 218.

In at least one example embodiment, an apparatus may provide for translation of language-based information. In at least one example embodiment, translation relates to rendering a source set of language-based information being in one language into translated set of language-based information being in a different language, such that the communicative conveyance of the source set of the language-based information is substantially similar to the translated set of language-based information. In at least one example embodiment, communicative conveyance of information relates to the meaning of the information as perceived by a user capable of determining such meaning. In at least one example embodiment, substantial similarity of communicative conveyance relates to deviation between communicative conveyance being attributable to one or more language mapping anomalies. In at least one example embodiment, alteration of communicative conveyance beyond a language mapping anomaly is considered a substantial difference of communicative conveyance. In at least one example embodiment, a language mapping anomaly relates to a difference between a source term and a target term that is based, at least in part, on inexact matching associated with translation. For example, the term for “spicy” in Spanish may translate to the word “hot” in English. Even though, in some contexts, the terms “spicy” and “hot” do not have identical communicative conveyance, such terms may have substantially similar communicative conveyance in that such difference is dependent on translation dependent information. In at least one example embodiment, translation relates to conversion of a source set of language-based information in a language into a translated set of language-based information of the same language such that the translated set of language-based information varies from the source set of language-based information by dialect, slang, and/or the like. For example, an apparatus may translate a set of English language-based information into a different set of English language-based information that is indicative of dialect associated with a pirate in a movie.

In at least one example embodiment an apparatus may provide for translation of an activity description. In such an embodiment, the apparatus may utilize translation dependent information to determine a translated activity description. In at least one example embodiment, translation dependent information relates to information utilized to translate one set of language-based information into a translated set of language-based information. For example, translation dependent information may be from information utilized to convert a description to a translated description. In at least one example embodiment, the description terminology information is distinct from translation dependent information.

FIG. 2C is a diagram illustrating information associated with determination of an activity description according to at least one example embodiment. In the example of FIG. 2C, activity description 222 may be based, at least in part, on interpreted activity 228 and description terminology information 226, and interpreted activity 228 may be based, at least in part, on sensor dependent information.

In at least one example embodiment, the apparatus determines the interpreted activity based, at least in part, on the sensor dependent information, such as sensor dependent information 204. For example, a part of the sensor dependent information may indicate user movement, and a part of the sensor dependent information may provide further context information that allows the apparatus to determine that the movement is indicative of the user shopping at a grocery store, dancing at a night club, walking down the street, working at the office, climbing up a mountain, and/or the like.

In at least one example embodiment, the interpreted activity is non-language-based information. For example, the interpreted activity may be information indicative of an activity absent any user representation of the activity. For example, the interpreted activity may be a data structure that identifies an activity.

In at least one example embodiment, the interpreted activity comprises language-based information. For example, the interpreted activity may comprise information that may be understandable as language to a user.

In at least one example embodiment, the interpreted activity is indicative of the activity being performed by the user. For example, the interpreted action may indicate that a user is sitting at a coffee shop, is dancing at a night club, is working at his desk, is running at the park, is riding her bike down a mountain, etc. In at least one example embodiment, the interpreted activity is absent any information relating to user expressive style. User expressive style may be similar as described regarding FIGS. 3D-3G. In at least one example embodiment, the interpreted activity is absent any historically supplemented activity description, historical information, and/or the like. A historically supplemented activity description may be similar as described regarding FIG. 2G. In at least one example embodiment, an interpreted activity is absent information associated with mounting of an apparatus. Information associated with mounting of an apparatus may be similar as described regarding FIGS. 2H-2I. In at least one example embodiment, the apparatus determines an interpreted activity similar as described regarding the activity description of FIGS. 2A-2B and 2D-2F.

In at least one example embodiment, the apparatus correlates an interpreted activity with, at least part of the description terminology information to determine the activity description. For example, the apparatus may utilize the description terminology information to determine how to describe the interpreted activity. In such an example, the description terminology may comprise a plurality of descriptions that may be applicable to an interpreted activity. Under such circumstances, the apparatus may select one or more descriptions comprised by the description terminology information for inclusion in the activity description. Such determination may be similar as described regarding FIG. 2I and FIGS. 3A-3G.

In at least one example embodiment in which the interpreted activity comprises language-based information, the communicative conveyance of the activity description is substantially different than the communicative conveyance of the interpreted activity. For example, the information represented by the activity description may be substantively different than the interpreted activity, similar as described regarding FIG. 2I and FIGS. 3A-3G.

FIG. 2D is a diagram illustrating information associated with determination of an activity description according to at least one example embodiment. In the example of FIG. 2D, activity description 232 may be based, at least in part, on sensor dependent information 234 and description terminology information 236. In the example of FIG. 2D, sensor dependent information 234 comprises sensor information 234A and sensor interpretation information 234B. In at least one example embodiment, an activity description is independent of sensor information. In at least one example embodiment, an activity description is independent of sensor interpretation information.

In at least one example embodiment, sensor information relates to information provided by a sensor. For example, sensor information may relate to information received from a motion sensor, a hall effect sensor, a proximity sensor, and/or the like. For example, sensor information may comprise location sensor information 244A of FIG. 2E, motion sensor information 244C of FIG. 2E, and/or the like. In at least one example embodiment, sensor interpretation information relates to information utilized to construe an implication of sensor information. For example, sensor interpretation information associated with a location sensor may relate to map information. In at least one example embodiment, sensor interpretation information associated with a proximity sensor relates to information for determining a position associated with proximity based, at least in part, on the proximity sensor information. For example, sensor interpretation information may comprise map information 244B, motion interpretation information 244D, and/or the like.

FIG. 2E is a diagram illustrating information associated with determination of an activity description according to at least one example embodiment. In the example of FIG. 2E, activity description 242 may be based, at least in part, on sensor dependent information 244 and description terminology information 246. In at least one example embodiment, sensor dependent information relates to motion information and/or position information. In the example of FIG. 2E, sensor dependent information 244 comprises location sensor information 244A, map information 244B, motion sensor information 244C, and motion interpretation information 244D.

In at least one example embodiment, motion information relates to motion sensor information and motion interpretation information. In at least one example embodiment, motion interpretation information relates to information associated with determining a movement indicated by motion sensor information. For example, motion sensor information may comprise accelerometer information representing movement over a period of time. In such an example, motion interpretation information may comprise information that allows the apparatus to determine a movement based, at least in part, on the accelerometer information. The apparatus may determine the movement to be a gesture, a type of movement, mere existence of movement, and/or the like. In at least one example embodiment, a gesture relates to a specific identified movement. For example a gesture may relate to movement of the apparatus in a predefined shape, such as a circle. In at least one example embodiment, a type of movement relates to identification of a general movement that the user may perform. For example, a type of movement may relate to walking, running, jumping, dancing, and/or the like.

In at least one example embodiment, location information relates to location sensor information and map information. In at least one example embodiment, map information relates to information associated with determining location information indicated by location sensor information. For example, location sensor information may comprise geographic location information representing a 2-dimensional location, a 3-dimensional location, and/or the like. In such an example, map information may comprise information that allows the apparatus to determine location information based, at least in part, on the geographic location. In at least one example embodiment, map information comprises navigational information, point of interest information, and/or the like. For example, the map information may identify a landmark, a commercial property, a personal property, a street, a building, a park, and/or the like, that is associated with a location. In such an example, the map information may allow the apparatus to determine that a user is at a coffee shop based, at least in part, on the location information and the map information.

In at least one example embodiment, an apparatus determines an activity description based, at least in part, on location information indicated by location sensor information and map information, and based, at least in part, on motion information indicated by motion sensor information and motion interpretation information. For example, the apparatus may evaluate the motion information and the location information such that the activity description is indicative of a motion that is consistent with an activity associated with the location information. For example, the motion may be indicative of walking. If the location relates to a park, the apparatus may determine the walking motion to indicate walking at the park. If the location relates to a store, the apparatus may determine the walking motion to indicate shopping at the store. If the location relates to a sidewalk, the apparatus may determine the walking motion to indicate walking to a destination. In another example, the motion may be indicative of quick movement with directional changes. If the location relates to a night club, the apparatus may determine the motion to indicate dancing at a night club. If the location relates to a gym, the apparatus may determine the movement to indicate training at the gym. If the location relates to a park, the apparatus may determine the motion to indicate playing at the park.

FIG. 2F is a diagram illustrating information associated with determination of an activity description according to at least one example embodiment. In the example of FIG. 2F, activity description 252 may be based, at least in part, on sensor dependent information 254 and description terminology information 256. In at least one example embodiment, an activity being performed by a user relates to an action being performed by the user at a location where the user is performing the action. In at least one example embodiment, an activity description comprises an action description and a location description. In the example of FIG. 2F, activity description 252 comprises action description 252A and location description 252B.

In at least one example embodiment, a location description relates to a descriptive representation of a location associated with activity that the device has determined to be performed by the user. In at least one example embodiment, the location description is based, at least in part, location information, such as location sensor information and map information. The location information, location sensor information, and map information may be similar as described regarding FIG. 2E. In at least one example embodiment, the location description may be based, at least in part, on an interpreted activity. The interpreted activity may be similar as described regarding FIG. 2C. In at least one example embodiment, an action description is based, at least in part on description terminology. The basis may be similar as described regarding activity description in relation to FIG. 2A.

In at least one example embodiment, a location description is based, at least in part, on motion information, such as motion sensor information and motion interpretation information. For example, the location information may indicate that the user is at a night club. If the motion information is consistent with dancing, the apparatus may determine the location description to relate to being the dance floor of the night club. If the motion information is consistent with sitting, the apparatus may determine the location description to relate to being at a table of the night club. In another example, the location information may indicate that the user is at a basketball stadium. If the motion information is consistent with sitting, the apparatus may determine the location description to relate to being on a seat at the basketball stadium. If the motion information is consistent with playing basketball, the apparatus may determine the location description to relate to being on a basketball court at the basketball stadium.

In at least one example embodiment, an action description relates to a descriptive representation of an action associated with activity that the device has determined to be performed by the user. In at least one example embodiment, the activity description is based, at least in part, motion information, such as motion sensor information and motion interpretation information. The motion information, motion sensor information, and motion interpretation information may be similar as described regarding FIG. 2E. In at least one example embodiment, the action description may be based, at least in part, on an interpreted activity. The interpreted activity may be similar as described regarding FIG. 2C. In at least one example embodiment, an action description is based, at least in part on description terminology. The basis may be similar as described regarding activity description in relation to FIG. 2A.

In at least one example embodiment, an activity description is based, at least in part, on location information, such as location sensor information and map information. For example, the motion information may indicate that the user is performing consistent rhythmic movement. If the location information is consistent with the user being at a night club, the apparatus may determine the action description to relate to dancing. If the location information is consistent with being at a gym, the apparatus may determine the action description to relate to training. In another example, the motion information may indicate that the user is walking. If the location information is consistent with being at a park, the apparatus may determine the action description to relate to walking. If the location information is consistent with being at a store, the apparatus may determine the action description to relate shopping.

FIG. 2G is a diagram illustrating information associated with determination of an activity description according to at least one example embodiment. As social interaction over electronic devices becomes more common in the daily lives of users, it has become increasingly desirable to users that their particular expressive style is represented in their communication. For example, a user may desire to supplement an activity description to provide more context regarding an activity that the user is performing, such as context associating the activity with a past event. Such information better mimics the way users communicate in manually generated communication. For example, instead of communicating “I am driving on Avenue K” a user may desire t communicate “I am driving home after a long day of shopping” or “I am running late driving to work”, to allow the recipient to better understand the context of the activity in relation to other events that the user has experienced. Such context may allow the user a greater degree of expressivity regarding automatically generated activity descriptions.

It may be desirable to provide an activity description that provides more context to the circumstances of a user activity than provided by sensor dependent information associated with the activity being performed by the user. For example, it may be desirable for a user to provide an activity description that reflects a deviation form a normally performed activity, an activity description that reflects that the activity is being performed in accordance with previous user behavior, an activity description that reflects that circumstances have not changed since a previous communication, and/or the like.

In at least one example embodiment, an activity description may be based, at least in part, on information associated with one or more past events. In at least one example embodiment, a past event may relate to any event associated with the user. For example a past event may relate to a scheduled meeting, a previous activity, a previous destination, and/or the like. In at least one example embodiment, an activity description that comprises a representation of information associated with one or more past events is referred to as a historically supplemented activity description. In at least one example embodiment, a historically supplemented activity description may be based, at least in part, on historical description terminology information and historical activity information. In the example of FIG. 2G, activity description 262 may be based, at least in part, on sensor dependent information 264, historical terminology information 268, historical activity information 269, and description terminology information 266. In at least one example embodiment, activity description 262 relates to a historically supplemented activity description.

Without limiting the scope of the claims in any way, at least one technical effect associated with providing such an activity description may be allowing a recipient of such an activity description to better understand the context of the activity represented by the activity description, to allow a recipient of such an activity description to understand interrelationship between the activity description and a past event, and/or the like. Without limiting the scope of the claims in any way, at least one technical effect associated with providing such an activity description may be allowing a user to better express the context of the activity represented by the activity description, to allow a user to express interrelationship between the activity description and a past event, and/or the like. For example, a user may desire to avoid manually supplementing an activity description to provide such context.

In at least one example embodiment, the historically supplemented activity description comprises the activity description and additional description information indicative of, at least part of, the historical activity information. In at least one example embodiment, an apparatus determines a historically supplemented activity description based, at least in part, on an activity description, historical activity information, and historical description terminology information. For example, the apparatus may determine the activity description, and supplement the activity description based, at least in part on the historical description terminology information and the historical activity information.

In at least one example embodiment, historical description terminology information relates to information associated with determination of how to represent a historical activity associated with a current activity by way of the historically supplemented activity description. In at least one example embodiment, the historical description terminology information relates to information that is distinct from the historically supplemented activity description. For example, the historical description terminology information may comprise terms that were precluded from the historically supplemented activity description. In at least one example embodiment, the historical description terminology information is independent of the sensor dependent information. For example, the historical description terminology information may be a separate data structure, may be received from a different source, and/or the like, from the sensor dependent information.

In at least one example embodiment, historical description terminology information comprises terminology indicative of a previous communication regarding, at least part of, the activity description. In at least one example embodiment, terminology indicative of a previous communication relates to terminology associated with a previous message that comprised a related activity description. For example, if a previous communication comprised an activity description, terminology indicative of the previous communication may comprise the term “still”, the term “continuing to”, the term “as before”, and/or the like. In at least one example embodiment, the historically supplemented activity description incorporates, at least part of the historical description terminology regarding, at least part of, the activity description. For example, if the previous communication comprised an activity description of “working at the office” and the current activity description relates to “working at the office”, the historically supplemented activity description may comprise “still working at the office”, “continuing to work at the office”, “working at the office, as before”, and/or the like. In such an example, the historical activity information may comprise information indicative of the previous communication regarding, at least part of, the activity description. For example, the historical activity information may comprise information associated with the previous communication of the activity description of “working at the office”.

In at least one example embodiment, historical description terminology information comprises terminology indicative of a deviation from previous user activity. In at least one example embodiment, terminology indicative of a deviation from previous user activity relates to terminology indicative of circumstances where the activity description is associated with an activity that differs from a previously determined activity description. For example, historical activity information may comprise information indicating that a previous user activity differs from a current user activity. In such circumstances, it may be desirable to provide a historically supplemented activity description indicative of the change in user activity.

For example, terminology indicative of a deviation from previous user activity may comprise the term “just finished”, the term “now”, the term “no longer”, and/or the like. In at least one example embodiment, the historically supplemented activity description incorporates, at least part of the historical description terminology regarding, at least part of, the activity description. For example, if the previous communication comprised an activity description of “working at the office” and the current activity description relates to “driving home”, the historically supplemented activity description may comprise “driving home from work”, “now driving home”, “no longer working at the office, driving home now”, “driving home, just finished working”, and/or the like.

In at least one example embodiment, terminology indicative of a deviation from previous user activity relates to terminology indicative of circumstances where the activity description is associated with an activity that represents a different activity than the user normal performs under similar circumstances. For example, terminology indicative of a deviation from previous user activity may comprise terms such as the term “still”, the term “unusually”, the term “oddly enough”, and or the like. For example, in circumstances where the activity description relates to work at a time after the user normally leaves work, the historically supplemented activity description may comprise “still working at the office”, “unusually working at the office right now”, “oddly enough, presently working at the office”, and/or the like. In such an example, the historical activity information may comprise information indicative of an activity that the user typically performs under similar circumstances. For example, the historical activity information may comprise information associated with the work schedule of a user.

In at least one example embodiment, historical activity information comprises information indicative of a past event. For example, the historical activity information may comprise timing information associated with a past even. An apparatus may utilize such timing information for correlation with timing information associated with an activity description. In at least one example embodiment, an apparatus determines a historically supplemented activity description based, at least in part, on correlation between timing associated with sensor dependent information associated with a user performing an activity, and timing information comprised by historical activity information. For example, an apparatus may determine inclusion of one or more terms comprised by the historical description terminology information based, at least in part, correlation of timing information associated with sensor dependent information associated with a user performing an activity, and timing information comprised by historical activity information based, at least in part, on correlation between the activity indicated by the sensor dependent information and the activity indicated by the historical activity information.

In at least one example, embodiment, determination of the historically supplemented activity description is further based, at least in part, on a historical terminology propensity setting. In at least one example embodiment, a historical terminology propensity setting relates to a setting that governs utilization of historical activity information and/or historical description terminology information. For example, a historical preference setting may relate to a setting that governs causation of determination of a historically supplemented activity description, preclusion of determination of the historically supplemented activity description, and/or the like.

In at least one example embodiment, an apparatus may cause supplementation of historical activity information. For example, the apparatus may supplement the historical activity information based, at least in part, on determination of an activity description. In such an example, the apparatus may supplement the historical activity information with information indicative of the activity description, information indicative of circumstances associated with the activity description, information indicative of the activity described by the activity description, and/or the like. For example, the apparatus may cause supplementation of historical activity information to include a time at which an activity description was determined. In at least one example embodiment, causation of supplementation of the historical activity information may relate to storing information in memory, sending a directive to store information in memory, and/or the like. In at least one example embodiment, supplementation of the historical activity information allows for future historical supplementation of description information based, at least in part, on the supplemented historical activity information.

Without limiting the scope of the claims in any way, at least one technical effect associated with providing a historically supplemented activity description based, at least in part, on historical activity information and historical description terminology information may be to provide a representation of the activity that is more similar to the way the user would express the activity to another person.

FIG. 2H is a diagram illustrating information associated with determination of an activity description according to at least one example embodiment. As social interaction over electronic devices becomes more common in the daily lives of users, it has become increasingly desirable to users that their particular expressive style is represented in their communication. Furthermore, as devices have become ubiquitous, not just in everyday life, but in all aspects of a user's life, it has become increasingly common for users to mount their electronic apparatus onto another apparatus associated with an activity that they are performing. Under such circumstances, it may be desirable to provide an activity description that is enhanced by information associated with the apparatus to which the electronic apparatus is mounted. For example, motion information associated with riding on skis down a slope may be very similar to motion information associated with riding a bicycle down a slope. However, a user may desire to describe such circumstances in very different ways. For example, even the verbs used to describe the action may differ, such as “skiing” versus “riding”. In another example, interpretation of motion information may differ. For example, motion indicative of jarring and bouncing when riding down a slope at high speeds may be indicative of a normal ride down a trail on a bicycle, but be indicative of an extremely problematic ski down a similar slope. In another example, there may be certain terminology associated with a particular apparatus to which the electronic apparatus is mounted. For example, some sports have their own jargon. Such jargon may apply to more than just the activities that are performed, but may extend to other aspects of the communication as well. For example, a statement such as “I just fudged a backside” may have meaning in snowboarding jargon, but may be inappropriate if applied to boating or driving.

It may be desirable to base an activity description on apparatus mounting information. Without limiting the scope of the claims in any way, at least one technical effect associated with basing the activity description on apparatus mounting information may be to allow for better interpretation of motion, allow for more particularized user expression, allow for more personalized user expression, etc.

In at least one example embodiment, an apparatus determines an activity description based, at least in part, on apparatus mounting information. In at least one example embodiment, apparatus mounting information relates to information associated with another apparatus to which the apparatus is mounted. For example, the apparatus may be mounted to an automobile, may be mounted to a bicycle, may be mounted to a snowboard, and/or the like. In at least one example embodiment, the apparatus may identify the mount by way of mechanical communication and/or electronic communication. For example, the apparatus may determine the mount information based, at least in part, on contact between the mount and the apparatus, such as the mounting of the apparatus causing actuation of one or more buttons. In another example, the apparatus may determine the mount by receiving a signal, such as a near-field communication signal.

In at least one example embodiment, apparatus mounting information relates to an identification of a mount apparatus. In at least one example embodiment, an apparatus to which another apparatus is mounted is a mount apparatus. For example, if a first apparatus is mounted to a second apparatus, the second apparatus may be referred to as a mount apparatus. Identification of the mount apparatus may be based, at least in part, on association of information received from the mount apparatus with stored information, such as a database, a table, and/or the like. Identification of the mount apparatus may be based, at least in part, on information conveyed by the mount apparatus, such as an electronically communicated data structure. In at least one example embodiment, an apparatus determines an activity description based, at least in part, on an identity of a mount apparatus.

In at least one example embodiment, apparatus mounting information relates to an identification of an activity classification associated with a mount apparatus to which the apparatus is mounted. Identification of the activity classification may be based, at least in part, on association of information received from the mount apparatus with stored information, such as a database, a table, and/or the like. Identification of the activity classification may be based, at least in part, on information conveyed by the mount apparatus, such as an electronically communicated data structure. In at least one example embodiment, an activity classification relates to a categorization of activities that may be performed in association with the mount apparatus. For example, if the mount apparatus is a bicycle, the activity classification may relate to activities associated with a bicycle, such as riding, standing, stopping, crashing, etc. In another example, if the mount apparatus is a snowboard, the activity classification may relate to activities associated with snowboarding, such as boarding, falling, turning, riding a lift, performing tricks, etc. In at least one example embodiment, the apparatus may determine the activity description based, at least in part on the activity classification. For example, the apparatus may preclude an activity description that is inconsistent with the activity classification, may favor an activity description that is consistent with the activity classification over an activity description that is inconsistent with the activity classification, and/or the like.

In at least one example embodiment, the apparatus mounting information relates to an identification of a sport associated with the mount apparatus. In such an example, determination of the activity description may be based, at least in part, on the identification of the sport. Identification of the sport may be based, at least in part, on association of information received from the mount apparatus with stored information, such as a database, a table, and/or the like. Identification of the sport may be based, at least in part, on information conveyed by the mount apparatus, such as an electronically communicated data structure. In at least one example embodiment, a sport relates to a categorization of activities that may be performed in association with a particularized use of the mount apparatus. For example, if the mount apparatus is a bicycle, the identification of the sport may be mountain biking, road cycling, and/or the like. For example, if identification of the sport is mountain biking, the activity classification may relate to activities associated with the sport of mountain biking, such as climbing, traversing, carrying the bicycle, stopping, crashing, etc. In another example, if the identification of the sport is road cycling, the activity classification may relate to activities associated with road cycling, such as turning, falling, accelerating, etc.

In the example of FIG. 2H, activity description 272 may be based, at least in part, on sensor dependent information 274, apparatus mounting information 278, and description terminology information 276.

FIG. 2I is a diagram illustrating information associated with determination of an activity description according to at least one example embodiment. In at least one example embodiment, description terminology information may comprise terminology associated with apparatus mounting information. For example, there may be terminology that is associated with a mount apparatus, associated with an activity classification associated with a mount apparatus, and/or the like. In at least one example embodiment, such terminology may be associated with a user's expressive style. For example, a user may prefer to utilize description terminology associated with the mount apparatus over description terminology that fails to incorporate terminology associated with the mount apparatus. In at least one example embodiment, description terminology information related to apparatus mounting information is referred to as mounting description terminology information. Therefore, the description terminology information may comprise mounting description terminology information.

In at least one example embodiment, determination of an activity description is based, at least in part, on mounting description terminology information. For example, the mounting description terminology information may comprise terminology that is applicable to the mount apparatus, similar as described regarding FIG. 2H. For example, if the mount apparatus is a backpack, the mounting description may relate to description terminology associated with a backpack, such as carrying, wearing, etc.

In at least one example embodiment, mounting description terminology information is associated with an activity classification. The activity classification may be similar as described regarding FIG. 2H. In at least one example embodiment, determination of an activity description is based, at least in part, on mounting description terminology information associated with an activity classification. For example, if the mount apparatus is a backpack, and the activity classification is hiking, mounting description terminology information may comprise terminology associated with climbing, resting, walking, etc.

In some circumstances, a sport associated with a mount apparatus may have an associated jargon. In many cases, such jargon may comprise terminology that has a different meaning outside of the context of the sport. In many cases, such jargon may comprise terminology that has no discernible meaning outside of the context of the sport. However, it may be desirable to be able to utilize sport jargon when communicating with recipients that are familiar with the jargon. For example, the user may gain or lose credibility with recipients based, at least in part, on the use of sports jargon. In such an example, a user may lose credibility with a recipient who is familiar with sports jargon and the user provides an activity description that fails to use the jargon. For example, a snowboarding user may lose credibility with other snowboarders by providing an activity description that states “proceeding at a high speed on a downward slope with rapid vibrations” versus “chattering on a brid”. Such lack of jargon inclusion may result in recipients perceiving a lack of familiarity with the sport. In particular, such terminology absent jargon may result in teasing from others in the snowboarding community. It may be desirable for a user to avoid such loss of credibility and teasing.

In at least one example embodiment, determination of the activity description is based, at least in part, on description terminology information indicative of a jargon associated with the activity classification. In at least one example embodiment, the description terminology indicative of jargon may relate to an action associated with description terminology information that is unassociated with jargon. For example, an activity associated with snowboarding may be described by non-jargon terminology to be “moving quickly” and may be described using snowboarding terminology to be “mobbing”. In such circumstances, it may be desirable to utilize the description terminology information indicative of the jargon instead of the description terminology information that is unassociated with the jargon.

In the example of FIG. 2I, activity description 282 may be based, at least in part, on sensor dependent information 284, and description terminology information 286, which may comprise apparatus mounting information 288.

FIGS. 3A-3G are diagrams illustrating information associated with determination of an activity description according to at least one example embodiment. The example of FIG. 3A-3G is merely an example of information associated with determination of an activity description, and does not limit the scope of the claims. For example, types of information may vary, a relationship between information may vary, and/or the like.

In at least one example embodiment, the apparatus utilizes one or more data structures in association with description terminology information. For example, the description terminology information may be comprised by one or more data structures. The examples of FIGS. 3A-3G relate to examples of description terminology information. Even though the examples of FIGS. 3A-3G illustrate description terminology information in relation to a table structure, one or more data structures associated with description terminology information may vary. Furthermore, even though the examples of FIGS. 3A-3G illustrate activity description terminology information in relation to sensor dependent information, one or more example embodiments may comprise description terminology information in relation to an interpreted activity, such as interpreted activity 228 of FIG. 2C.

FIG. 3A is a diagram illustrating information associated with determination of an activity description according to at least one example embodiment. In at least one example embodiment, description terminology information comprises, at least part of, an activity description in relation to associated sensor dependent information. For example, the description terminology information may provide information correlating to sensor dependent information that is indicative of an activity that may be suitably described by the associated activity description.

FIG. 3A illustrates description terminology information comprising activity description 301, which relates to sensor dependent information 302, activity description 303, which relates to sensor dependent information 304, and activity description 305, which relates to sensor dependent information 306. In the example of FIG. 3A, the description terminology information may comprise other activity description information associated with other sensor dependent information. In at least one example embodiment, the relation between sensor dependent information and, at least part of, an activity description is referred to as a relation based, at least in part, on sensor dependent information categorization. For example, the activity description information may be categorized by sensor dependent information.

In at least one example embodiment, description terminology information comprises description terminology information in relation to an interpreted activity. In at least one example embodiment, the relation between, at least part of, an interpreted activity and, at least part of, an activity description is referred to as a relation based, at least in part, on interpreted activity categorization. For example, the activity description information may be categorized by, at least part of, an interpreted activity.

In at least one example embodiment, an apparatus may determine an activity description based, at least in part, on correlation between received sensor dependent information and sensor dependent information of a sensor dependent information categorization of description terminology information. For example, the apparatus may determine to utilize activity description 301 based, at least in part, on correlation between sensor dependent information 302 and received sensor dependent information. In at least one example embodiment, an apparatus may determine an activity description based, at least in part, on correlation between an interpreted action and interpreted action information of an interpreted action categorization of description terminology information.

FIG. 3B is a diagram illustrating information associated with determination of an activity description according to at least one example embodiment. As described regarding FIG. 2F, an activity description may comprise an action description.

In at least one example embodiment, description terminology information comprises, at least part of, an action description in relation to associated sensor dependent information. For example, the description terminology information may provide information correlating to sensor dependent information that is indicative of an action that may be suitably described by the associated action description.

FIG. 3B illustrates description terminology information comprising action description 311A, which relates to sensor dependent information 312A, action description 313A, which relates to sensor dependent information 314A, and action description 315A, which relates to sensor dependent information 316A. In the example of FIG. 3B, the description terminology information may comprise other action description information associated with other sensor dependent information. In at least one example embodiment, the relation between sensor dependent information and, at least part of, an action description is referred to as a relation based, at least in part, on sensor dependent information categorization. For example, the action description information may be categorized by sensor dependent information.

In at least one example embodiment, description terminology information comprises description terminology information in relation to an interpreted activity. In at least one example embodiment, the relation between, at least part of, an interpreted activity and, at least part of, an action description is referred to as a relation based, at least in part, on interpreted activity categorization. For example, the action description information may be categorized by, at least part of, an interpreted activity.

In at least one example embodiment, an apparatus may determine an action description based, at least in part, on correlation between received sensor dependent information and sensor dependent information of a sensor dependent information categorization of description terminology information. For example, the apparatus may determine to utilize action description 311A based, at least in part, on correlation between sensor dependent information 312A and received sensor dependent information. In at least one example embodiment, an apparatus may determine an action description based, at least in part, on correlation between an interpreted action and interpreted action information of an interpreted action categorization of description terminology information.

FIG. 3C is a diagram illustrating information associated with determination of an activity description according to at least one example embodiment. In at least one example embodiment, description terminology information comprises, at least part of, a location description in relation to associated sensor dependent information. For example, the description terminology information may provide information correlating to sensor dependent information that is indicative of a location that may be suitably described by the associated location description.

FIG. 3C illustrates description terminology information comprising location description 311B, which relates to sensor dependent information 312B, location description 313B, which relates to sensor dependent information 314B, and location description 315B, which relates to sensor dependent information 316B. In the example of FIG. 3C, the description terminology information may comprise other location description information associated with other sensor dependent information. In at least one example embodiment, the relation between sensor dependent information and, at least part of, a location description is referred to as a relation based, at least in part, on sensor dependent information categorization. For example, the location description information may be categorized by sensor dependent information.

In at least one example embodiment, description terminology information comprises description terminology information in relation to an interpreted activity. In at least one example embodiment, the relation between, at least part of, an interpreted activity and, at least part of, a location description is referred to as a relation based, at least in part, on interpreted activity categorization. For example, the location description information may be categorized by, at least part of, an interpreted activity.

In at least one example embodiment, an apparatus may determine a location description based, at least in part, on correlation between received sensor dependent information and sensor dependent information of a sensor dependent information categorization of description terminology information. For example, the apparatus may determine to utilize location description 311B based, at least in part, on correlation between sensor dependent information 312B and received sensor dependent information. In at least one example embodiment, an apparatus may determine a location description based, at least in part, on correlation between an interpreted action and interpreted action information of an interpreted action categorization of description terminology information.

FIG. 3D is a diagram illustrating information associated with determination of an activity description according to at least one example embodiment. A user may desire to control a level of seriousness associated with an activity description. For example, a user may desire an activity description to contain whimsical terminology. In many interactions, an appropriate level of seriousness in an expressive style may be desirable to convey characteristics such as a professional relationship, a personal relationship, a playful mood, a serious mood, and/or the like. For example, for a communication regarding a business activity to a colleague, it may be desirable to provide an activity description associated with a high level of seriousness. In another example, for a communication regarding a hobby to a friend, it may be desirable to provide an activity description associated with a low level of seriousness.

In at least one example embodiment, an activity description may be determined based, at least in part, on at least one terminology propensity setting. In at least one example embodiment, a terminology propensity setting relates to a setting that governs utilization of one or more terms based, at least in part, on the terminology propensity setting. In at least one example embodiment, a terminology propensity setting may relate to one or more description terminology information classifications. In at least one example embodiment, a terminology propensity setting is indicative of at least one categorization of description terminology information. For example, a terminology propensity setting may govern selection of, at least part of, an activity description based, at least in part, on correlation between the terminology propensity setting and a description terminology information classification. In at least one example embodiment, a terminology propensity setting may be indicative of a level associated with a description terminology information categorization.

For example, the terminology propensity setting may relate to a threshold. In such an example, the terminology preference threshold may relate to determination of an activity description based, at least in part, on exclusion of description terminology information relating to a description terminology information categorization that is beyond the threshold. For example, if the terminology propensity setting relates to a minimum level threshold, the apparatus may determine a level below the minimum level threshold to be beyond the threshold. In another example, if the terminology propensity setting relates to a maximum level threshold, the apparatus may determine a level above the maximum level threshold to be beyond the threshold.

In another example, the terminology propensity setting may relate to a preference. In such an example, the terminology preference may relate to determination of an activity description based, at least in part, on selection of description terminology information relating to a description terminology information categorization that is similar to the preference. In at least one example embodiment, the apparatus may determine similarity based, at least in part, on the terminology preference being the same as a description terminology information categorization level. In at least one example embodiment, the apparatus may determine similarity based, at least in part, on identification of a description terminology information categorization level that is nearer to the terminology preferences level than other description terminology information categorization level. For example, if the terminology propensity setting relates to an identified preference level, the apparatus may determine the nearest description terminology information categorization level, above or below, the preference level.

In at least one example embodiment, a description terminology categorization relates to a parameter associated with, at least part of, an activity description that allows for differentiation of activity description based, at least in part on the categorization. In at least one example embodiment, the categorization relates to a determined level of, at least part of, an activity description that represents a qualitative value regarding a scale of desirability that an activity description may have in association with the categorization.

In at least one example embodiment, description terminology information comprises a seriousness level categorization. In at least one example embodiment, a seriousness level categorization relates to a categorization regarding a desired level of seriousness associated with utilization of an associated activity description. In at least one example embodiment, a high seriousness level may relate to an activity description that relates to less whimsy than a low seriousness level. For example, an activity description having whimsy may comprise more descriptive content than an activity description that is serious. For example, a whimsical activity description may comprise more adjectives, adverbs, and/or the like. In another example, a whimsical activity description may comprise a metaphor, a simile, and/or the like. For example, an activity description may relate to dancing. In such an example, a serious activity description relating to dancing may comprise “dancing” without further elaboration on “dancing”, or with technically descriptive adjectives or adverbs describing dancing, such as “dancing quickly”. In another example, a whimsical activity description relating to dancing may comprise dancing being described by a simile, such as “dancing like crazy” or “dancing like a maniac”.

In at least one example embodiment, a level of seriousness associated with an activity description may be based, at least in part, on a predetermined value, a user provided value, a learned value, and/or the like. For example, a developer of description terminology information may decide a level of seriousness that is applicable to an activity description. In another example, a user may provide a seriousness level that the user associates with an activity description. In such an example, the user may provide such a value by way of performing a correction to an activity description. In such an example, if the correction relates to an activity description having more than one part, the seriousness level may be learned based, at least in part, on evaluation of a history of user corrections to determine how the corrections may apply to any term of the description terminology information.

In at least one example embodiment, a desired level of seriousness for an activity description may be based, at least in part, on a seriousness level identifier. The seriousness level indicated by the seriousness level identifier may relate to a seriousness threshold, a seriousness preference, and/or the like. In at least one example embodiment, the seriousness level identifier is based, at least in part, on a user setting. For example the user may provide a setting that corresponds to a desired seriousness level for generation of an activity description. In at least one example embodiment, a seriousness level identifier varies based, at least in part on an intended recipient of the activity description. For example, a friend recipient may have an associated lower level of seriousness than an employer level of seriousness. In such an example, the user may desire less whimsy in activity descriptions for communication to an employer than in activity description for communication to a friend. In such an example, the user may desire an activity associated with walking at a park to be described as “walking at the park” to an employer, and be described as “meandering aimlessly at the park” to a friend.

In at least one example embodiment, a low level of seriousness may be associated with description terminology associated with terminology that is discouraged in a professional environment, such as sarcasm, exaggeration, profanity, self-abasement, self-aggrandizement, insult, and/or the like. For example, a low level of seriousness may relate to terminology such as “foolishly”, “valiantly”, “superior to”, etc.

FIG. 3D illustrates description terminology information comprising activity description 321, which relates to sensor dependent information 322 and seriousness level 323, activity description 324, which relates to sensor dependent information 325 and seriousness level 326, and activity description 327, which relates to sensor dependent information 328 and seriousness level 329. In the example of FIG. 3D, the description terminology information may comprise other activity description information associated with other sensor dependent information and other seriousness levels.

In at least one example embodiment, sensor dependent information 322 is the same as sensor dependent information 325, seriousness level 323 differs from seriousness level 326, and activity description 321 differs from activity description 324. Such an example relates to an activity performed by the user that may be described in differing ways based, at least in part, on a desired seriousness level.

FIG. 3E is a diagram illustrating information associated with determination of an activity description according to at least one example embodiment. A user may desire to control a level of specificity associated with an activity description. For example, a user may desire an activity description to contain terminology ranging between vague terminology and specific terminology. In many interactions, an appropriate level of specificity in an expressive style may be desirable to convey characteristics such as a professional relationship, a personal relationship, a level of trust, a level of secrecy, and/or the like. For example, for a communication regarding a business activity to a colleague, it may be desirable to provide an activity description associated with a high level of specificity. In another example, for a communication regarding a hobby to a colleague, it may be desirable to provide an activity description associated with a low level of specificity.

In at least one example embodiment, description terminology information comprises a specificity level categorization. In at least one example embodiment, a specificity level categorization relates to a categorization regarding a desired level of specificity associated with utilization of an associated activity description. In at least one example embodiment, a high specificity level may relate to an activity description that provides a high level of descriptive precision regarding an activity description. For example, an activity description having high level of specificity may comprise more descriptive content than an activity description that has a lower specificity. For example, a less specific activity description may be vaguer than a specific activity description. For example, an activity may relate to dancing with a high level of intensity at a location. An activity description associated with a high level of specificity may comprise “dancing vigorously” at the location. An activity description associated with a lower level of specificity may comprise “dancing” at the location. An activity description associated with an even lower level of specificity may comprise “moving” at the location. An activity description associated with a lowest level of specificity may omit an activity description.

In at least one example embodiment, a level of specificity associated with an activity description may be based, at least in part, on a predetermined value, a user provided value, a learned value, and/or the like. For example, a developer of description terminology information may decide a level of specificity that is applicable to an activity description. In another example, a user may provide a specificity level that the user associates with an activity description. In such an example, the user may provide such a value by way of performing a correction to an activity description. In such an example, if the correction relates to an activity description having more than one part, the specificity level may be learned based, at least in part, on evaluation of a history of user corrections to determine how the corrections may apply to any term of the description terminology information.

In at least one example embodiment, a desired level of specificity for an activity description may be based, at least in part, on a specificity level identifier. The specificity level indicated by the specificity level identifier may relate to a specificity threshold, a specificity preference, and/or the like. In at least one example embodiment, the specificity level identifier is based, at least in part, on a user setting. For example the user may provide a setting that corresponds to a desired specificity level for generation of an activity description. In at least one example embodiment, a specificity level identifier varies based, at least in part on an intended recipient of the activity description. For example, a friend recipient may have an associated higher level of specificity than an employer level of specificity. In such an example, the user may desire more vagueness in activity descriptions for communication to an employer than in activity description for communication to a friend. In such an example, the user may desire an activity associated with drinking at a bar in an airport to be described as “sitting at the airport” to an employer, and be described as “drinking at the bar at the airport” to a friend. In at least one example embodiment, differing level of specificity may be characterized by varying degrees of granularity of information.

In at least one example embodiment, a specificity level identifier may be associated with one or more privacy setting. For example, a user may desire to avoid providing location description more precise than a particular specificity level. In at least one example embodiment, the privacy setting may be associated with a security setting. For example, a parent may desire to prevent a child from sharing precise details regarding a location and/or an action.

In at least one example embodiment, a specificity level relates to at least one of an action specificity level or a location specificity level. In at least one example embodiment, a specificity level identifier relates to at least one of an action specificity level identifier or a location specificity level identifier. In circumstances where the specificity level relates to both an action specificity and a location specificity, the action specificity level identifier may differ from the location specificity level identifier.

FIG. 3E illustrates description terminology information comprising activity description 331, which relates to sensor dependent information 332 and specificity level 333, activity description 334, which relates to sensor dependent information 335 and specificity level 336, and activity description 337, which relates to sensor dependent information 338 and specificity level 339. In the example of FIG. 3E, the description terminology information may comprise other activity description information associated with other sensor dependent information and other specificity levels.

In at least one example embodiment, sensor dependent information 332 is the same as sensor dependent information 335, specificity level 333 differs from specificity level 336, and activity description 331 differs from activity description 334. Such an example relates to an activity performed by the user that may be described in differing ways based, at least in part, on a desired specificity level.

FIG. 3F is a diagram illustrating information associated with determination of an activity description according to at least one example embodiment. In at least one example embodiment, description terminology information comprises mount description terminology information similar as described regarding FIG. 2I. A user may desire to control a level of mount terminology associated with an activity description. For example, a user may desire an activity description to contain a range between a large degree of mounting description terminology information and no mounting description terminology information. In many interactions, an appropriate level of mounting description terminology information in an expressive style may be desirable to convey characteristics such as familiarity with an activity associated with a mount apparatus, respect for a recipient's lack of familiarity with an activity associated with a mount apparatus, a relationship of formality, a relationship of informality, and/or the like. For example, for a communication regarding snowboarding to an employer, it may be desirable to provide an activity description associated with a low level of snowboarding description terminology. In another example, for a communication regarding snowboarding to a fellow snowboarder, it may be desirable to provide an activity description associated with a high level of snowboarding description terminology.

In at least one example embodiment, description terminology information comprises a mount terminology level categorization. In at least one example embodiment, a mount terminology level categorization relates to a categorization regarding a desired level of mount terminology associated with utilization of an associated activity description. In at least one example embodiment, a high mount terminology level may relate to an activity description that provides a high level of mount terminology regarding an activity description. For example, an activity description having high level of mount terminology may comprise more jargon than an activity description that has a lower mount terminology level.

In at least one example embodiment, a level of mount terminology associated with an activity description may be based, at least in part, on a predetermined value, a user provided value, a learned value, and/or the like. For example, a developer of description terminology information may decide a level of mount terminology that is applicable to an activity description. In another example, a user may provide a mount terminology level that the user associates with an activity description. In such an example, the user may provide such a value by way of performing a correction to an activity description. In such an example, if the correction relates to an activity description having more than one part, the mount terminology level may be learned based, at least in part, on evaluation of a history of user corrections to determine how the corrections may apply to any term of the description terminology information.

In at least one example embodiment, a desired level of mount terminology for an activity description may be based, at least in part, on a mount terminology level identifier. The mount terminology level indicated by the mount terminology level identifier may relate to a mount terminology threshold, a mount terminology preference, and/or the like. In at least one example embodiment, the mount terminology level identifier is based, at least in part, on a user setting. For example the user may provide a setting that corresponds to a desired mount terminology level for generation of an activity description. In at least one example embodiment, a mount terminology level identifier varies based, at least in part on an intended recipient of the activity description.

FIG. 3F illustrates description terminology information comprising activity description 341, which relates to sensor dependent information 342 and mount terminology level 343, activity description 344, which relates to sensor dependent information 345 and mount terminology level 346, activity description 347, which relates to sensor dependent information 348 and mount terminology level 349, comprising mount activity description 351, which relates to sensor dependent information 352 and mount terminology level 353, and mount activity description 354, which relates to sensor dependent information 355 and mount terminology level 356. In the example of FIG. 3F, the description terminology information may comprise other activity description information associated with other sensor dependent information and other mount terminology levels. In the example of FIG. 3F, activity descriptions 341, 344 and 347 are respectively associated with a low mount terminology level 343, 346, and 349. In the example of FIG. 3F, mount activity descriptions 351 and 354 are respectively associated with a high mount terminology level 353 and 356.

FIG. 3G is a diagram illustrating information associated with determination of an activity description according to at least one example embodiment. It may be desirable for a user to be able to control multiple description terminology information categorizations. The example of FIG. 3G illustrates activity description 361, which relates to sensor dependent information 362, mount terminology level 363, seriousness level categorization 364, and specificity level categorization 365, activity description 366, which relates to sensor dependent information 367, mount terminology level 368, seriousness level categorization 369, and specificity level categorization 370, activity description 371, which relates to sensor dependent information 372, mount terminology level 373, seriousness level categorization 374, and specificity level categorization 375, activity description 376, which relates to sensor dependent information 377, mount terminology level 378, seriousness level categorization 379, and specificity level categorization 380. Even though the example of FIG. 3G represents a combination of the categorizations of FIGS. 3D-3F, at least one example embodiment comprises a different permutation of categorizations that includes and/or omits at least one of such categorizations and/or any other categorization.

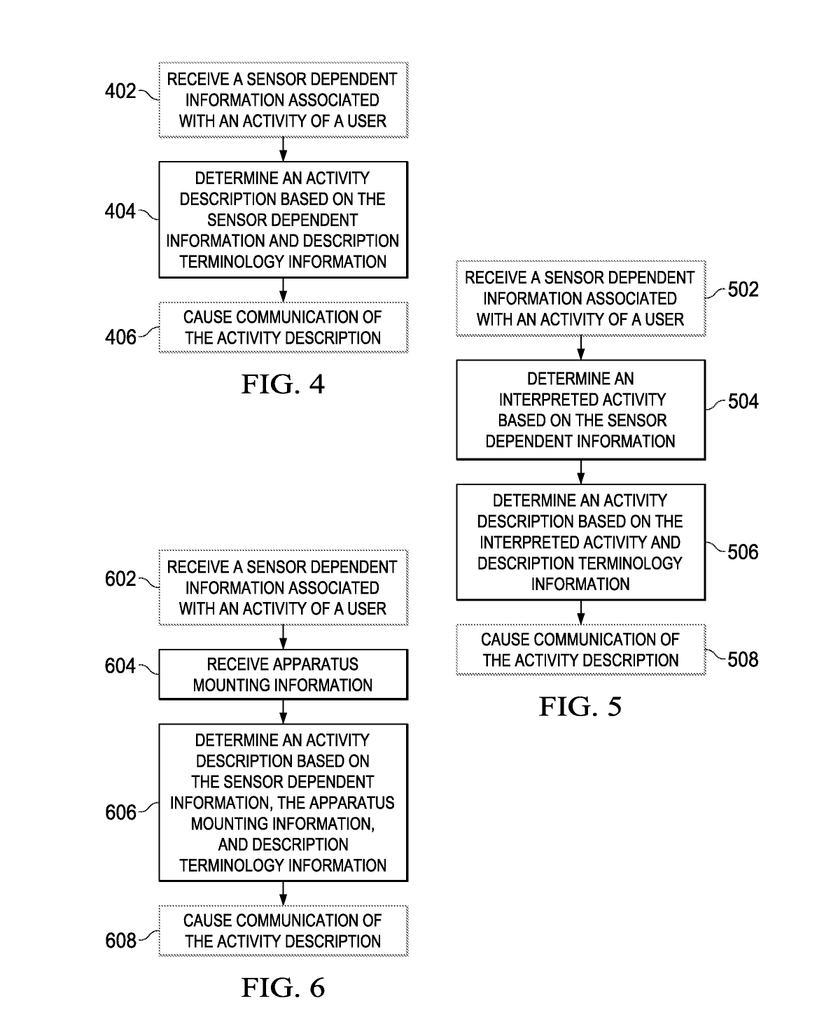

FIG. 4 is a flow diagram illustrating activities associated with determining an activity description according to at least one example embodiment. In at least one example embodiment, there is a set of operations that corresponds the activities of FIG. 4. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 4.

At block 402, the apparatus receives a sensor dependent information associated with an activity of a user. The receiving, the sensor dependent information, and the association with an activity of the user may be similar as described regarding FIGS. 2A-2I.

At block 404, the apparatus determines an activity description based, at least in part, on the sensor dependent information and a description terminology information. The determination, the activity description, the sensor dependent information, and the description terminology information may be similar as described regarding FIG. 2A-2I and FIGS. 3A-3G.

At block 406, the apparatus causes communication of the activity description. The communication may be similar as described regarding FIGS. 2A-2I.

FIG. 5 is a flow diagram illustrating activities associated with determining an activity description according to at least one example embodiment. In at least one example embodiment, there is a set of operations that corresponds the activities of FIG. 5. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 5.

At block 502, the apparatus receives a sensor dependent information associated with an activity of a user, similarly as described regarding block 402 of FIG. 4. At block 504, the apparatus determines an interpreted activity based, at least in part, on the sensor dependent information. The determination and the interpreted activity may be similar as described regarding FIGS. 2A-2I. At block 506, the apparatus determines an activity description based, at least in part, on the interpreted activity and a description terminology information. The determination, the activity description, the interpreted activity, and the description terminology information may be similar as described regarding FIG. 2A-2I and FIGS. 3A-3G. At block 508, the apparatus causes communication of the activity description similarly as described regarding block 406 of FIG. 4.

FIG. 6 is a flow diagram illustrating activities associated with determining an activity description according to at least one example embodiment. In at least one example embodiment, there is a set of operations that corresponds the activities of FIG. 6. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 6.

At block 602, the apparatus receives a sensor dependent information associated with an activity of a user, similarly as described regarding block 402 of FIG. 4. At block 604, the apparatus receives apparatus mounting information. The receipt and the apparatus mounting information may be similar as described regarding FIGS. 2A-2I and FIGS. 3A-3G. At block 606, the apparatus determines an activity description based, at least in part, on sensor dependent information, the apparatus mounting information, and a description terminology information. The determination, the activity description, the sensor dependent information, the apparatus mounting information, and the description terminology information may be similar as described regarding FIG. 2A-2I and FIGS. 3A-3G. At block 608, the apparatus causes communication of the activity description similarly as described regarding block 406 of FIG. 4.

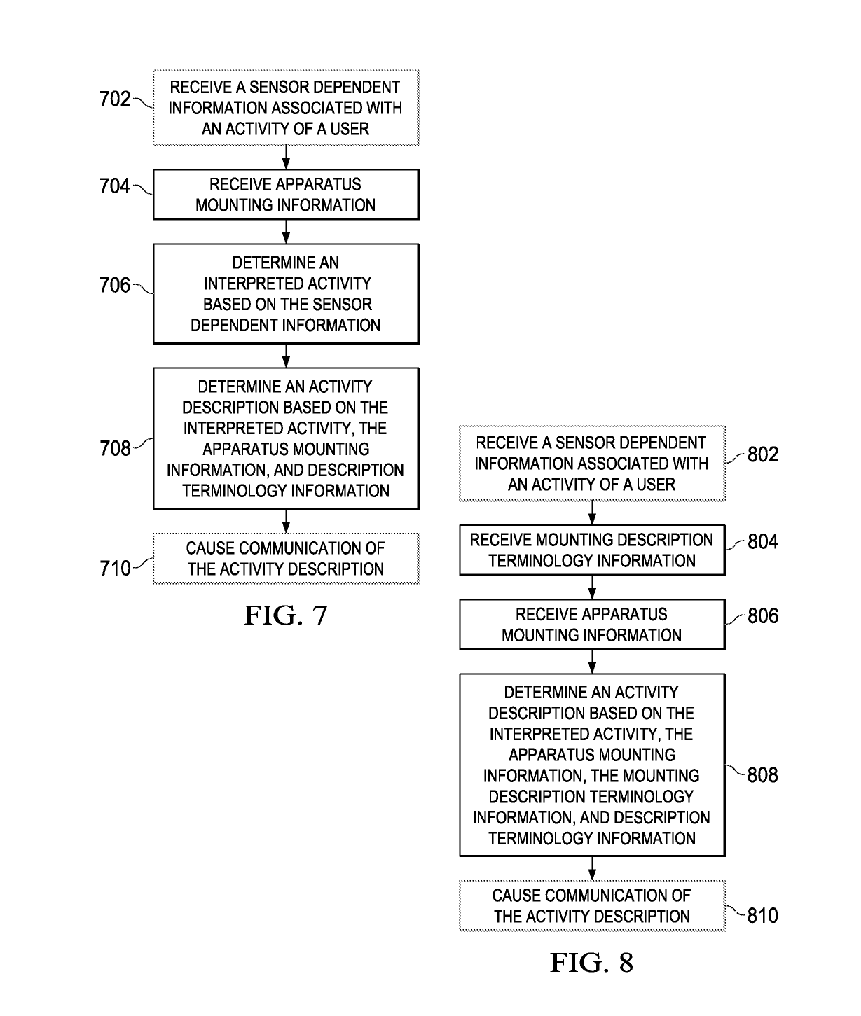

FIG. 7 is a flow diagram illustrating activities associated with determining an activity description according to at least one example embodiment. In at least one example embodiment, there is a set of operations that corresponds the activities of FIG. 7. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 7.

At block 702, the apparatus receives a sensor dependent information associated with an activity of a user, similarly as described regarding block 402 of FIG. 4. At block 704, the apparatus receives apparatus mounting information, similarly as described regarding block 604 of FIG. 6. At block 706, the apparatus determines an interpreted activity based, at least in part, on the sensor dependent information, similarly as described regarding block 504 of FIG. 5. At block 708, the apparatus determines an activity description based, at least in part, on the interpreted action, the apparatus mounting information, and a description terminology information. The determination, the activity description, the interpreted action, the apparatus mounting information, and the description terminology information may be similar as described regarding FIG. 2A-2I and FIGS. 3A-3G. At block 710, the apparatus causes communication of the activity description similarly as described regarding block 406 of FIG. 4.

FIG. 8 is a flow diagram illustrating activities associated with determining an activity description according to at least one example embodiment. In at least one example embodiment, there is a set of operations that corresponds the activities of FIG. 8. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 8.

In at least one example embodiment, mounting description terminology is received independently from description terminology information similar as described regarding FIGS. 2H-2I. For example, it may be desirable to store less than all possible mounting description terminology information sets. In such an example, it may be desirable to receive at least one mounting description terminology information associated with at least one mount apparatus. For example, a mount apparatus may communicate mounting description terminology information. In another example, mounting description terminology may be retrieved from a repository, such as a server.

At block 802, the apparatus receives a sensor dependent information associated with an activity of a user, similarly as described regarding block 402 of FIG. 4. At block 804, the apparatus receives mounting description terminology information. The mounting description terminology information may be similar as described regarding FIGS. 2A-2I and FIGS. 3A-3G. At block 806, the apparatus receives apparatus mounting information, similarly as described regarding block 604 of FIG. 6. At block 808, the apparatus determines an activity description based, at least in part, on the sensor dependent information, the apparatus mounting information, the mounting description terminology information, and a description terminology information. The determination, the sensor dependent information, the interpreted action, the apparatus mounting information, the mounting description terminology information, and the description terminology information may be similar as described regarding FIG. 2A-2I and FIGS. 3A-3G. At block 810, the apparatus causes communication of the activity description similarly as described regarding block 406 of FIG. 4.

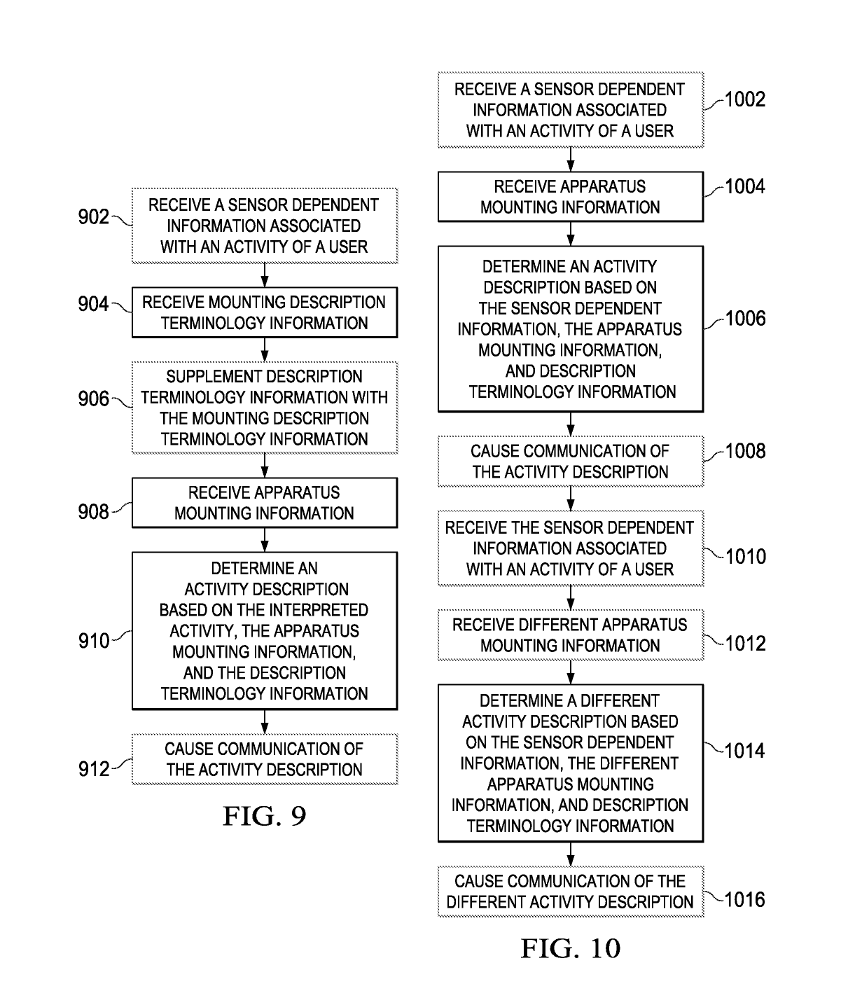

FIG. 9 is a flow diagram illustrating activities associated with determining an activity description according to at least one example embodiment. In at least one example embodiment, there is a set of operations that corresponds the activities of FIG. 9. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 9.

It may be desirable to be able to adapt description terminology information based, at least in part, on apparatus mounting information. For example, a user may desire to utilize mounting description terminology information, but may desire to avoid having storage of the apparatus consumed by mounting description terminology information that pertains to a mount apparatus that the user does not utilize. Under such circumstances, it may be desirable to receive the mounting description terminology and supplement the description terminology information with the received mounting description terminology information.

At block 902, the apparatus receives a sensor dependent information associated with an activity of a user, similarly as described regarding block 402 of FIG. 4. At block 904, the apparatus receives mounting description terminology information, similarly as described regarding block 804 of FIG. 8. At block 906, the apparatus causes supplementation of the description terminology information with the mounting description terminology information. Supplementation of the apparatus may comprise storing the mounting description terminology information with the description terminology information, cross referencing the mounting terminology information with the description terminology information, and/or the like. At block 908, the apparatus receives apparatus mounting information, similarly as described regarding block 604 of FIG. 6. At block 910, the apparatus determines an activity description based, at least in part, on the sensor dependent information, the apparatus mounting information, and the supplemented description terminology information. The determination, the sensor dependent information, the interpreted action, the mounting description terminology information, and the supplemented description terminology information may be similar as described regarding FIG. 2A-2I and FIGS. 3A-3G. At block 912, the apparatus causes communication of the activity description similarly as described regarding block 406 of FIG. 4.

FIG. 10 is a flow diagram illustrating activities associated with determining an activity description according to at least one example embodiment. In at least one example embodiment, there is a set of operations that corresponds the activities of FIG. 10. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 10.

In at least one example embodiment the same sensor dependent information may relate to different activity description in circumstances where the apparatus mounting information differs.

At block 1002, the apparatus receives a sensor dependent information associated with an activity of a user, similarly as described regarding block 402 of FIG. 4. At block 1004, the apparatus receives apparatus mounting information, similarly as described regarding block 604 of FIG. 6. At block 1006, the apparatus determines an activity description based, at least in part, on sensor dependent information, the apparatus mounting information, and a description terminology information, similarly as described regarding block 606 of FIG. 6. At block 1008, the apparatus causes communication of the activity description similarly as described regarding block 406 of FIG. 4.

At block 1010, the apparatus receives the same sensor dependent information associated with the same activity of the user as described regarding block 1002. At block 1012, the apparatus receives different apparatus mounting information from the apparatus mounting information of block 1004. At block 1014, the apparatus determines an activity description based, at least in part, on the same sensor dependent information, the different apparatus mounting information, and the description terminology information, such that the activity description determined at block 1014 is different than the activity description determined at block 1006. At block 1016, the apparatus causes communication of the different activity description.

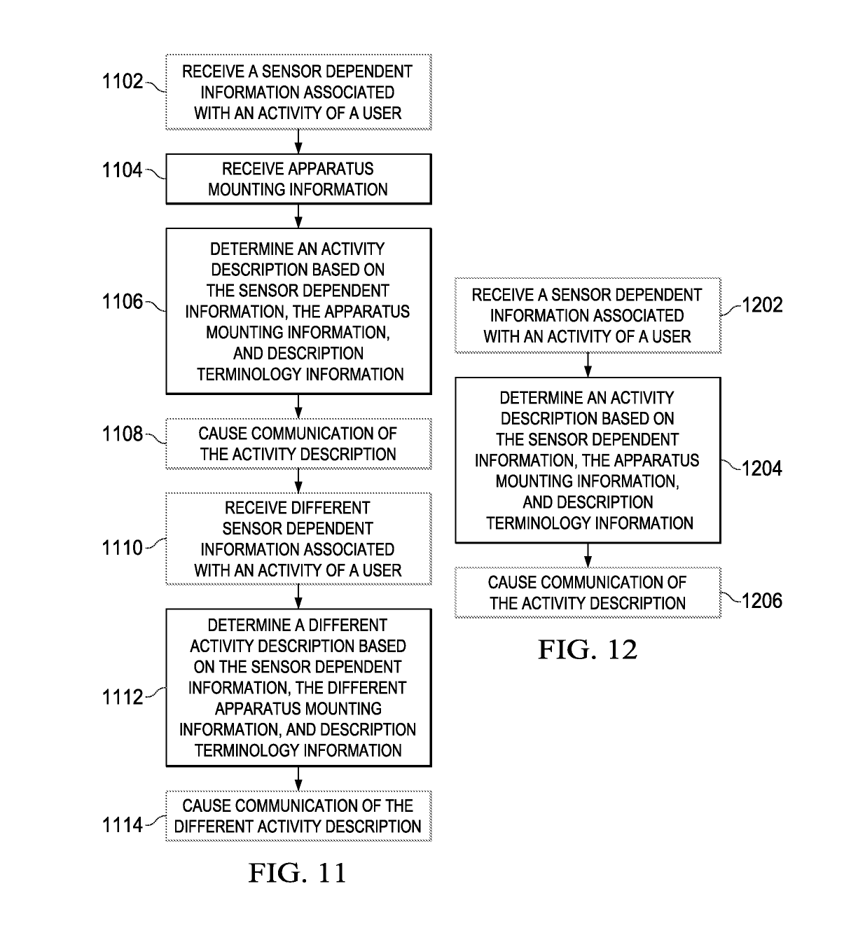

FIG. 11 is a flow diagram illustrating activities associated with determining an activity description according to at least one example embodiment. In at least one example embodiment, there is a set of operations that corresponds the activities of FIG. 11. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 11.

In at least one example embodiment the same apparatus mounting information may relate to different activity description in circumstances where the sensor dependent information differs.

At block 1102, the apparatus receives a sensor dependent information associated with an activity of a user, similarly as described regarding block 402 of FIG. 4. At block 1104, the apparatus receives apparatus mounting information, similarly as described regarding block 604 of FIG. 6. At block 1106, the apparatus determines an activity description based, at least in part, on sensor dependent information, the apparatus mounting information, and a description terminology information, similarly as described regarding block 606 of FIG. 6. At block 1108, the apparatus causes communication of the activity description similarly as described regarding block 406 of FIG. 4.

At block 1110, the apparatus receives a different sensor dependent information than the sensor dependent information described regarding block 1102, associated with a different activity of the user than the activity of the user described regarding block 1102. At block 1112, the apparatus receives the same apparatus mounting information as the apparatus mounting information of block 1104. At block 1114, the apparatus determines an activity description based, at least in part, on the different sensor dependent information, the same apparatus mounting information, and the description terminology information, such that the activity description determined at block 1114 is different than the activity description determined at block 1106. At block 1116, the apparatus causes communication of the different activity description.

FIG. 12 is a flow diagram illustrating activities associated with determining an activity description according to at least one example embodiment. In at least one example embodiment, there is a set of operations that corresponds the activities of FIG. 12. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 12.

At block 1202, the apparatus receives a sensor dependent information associated with an activity of a user, similarly as described regarding block 402 of FIG. 4. At block 1204, the apparatus determines an activity description based, at least in part, on the sensor dependent information, a description terminology information, and a seriousness level identifier, at least part of the description terminology information being associated with a seriousness level associated with the seriousness level identifier. The description terminology information, the seriousness level identifier, the description terminology information, and the seriousness level may be similar as described regarding FIGS. 2A-2I and FIGS. 3A-3G. At block 1206, the apparatus causes communication of the activity description similarly as described regarding block 406 of FIG. 4.

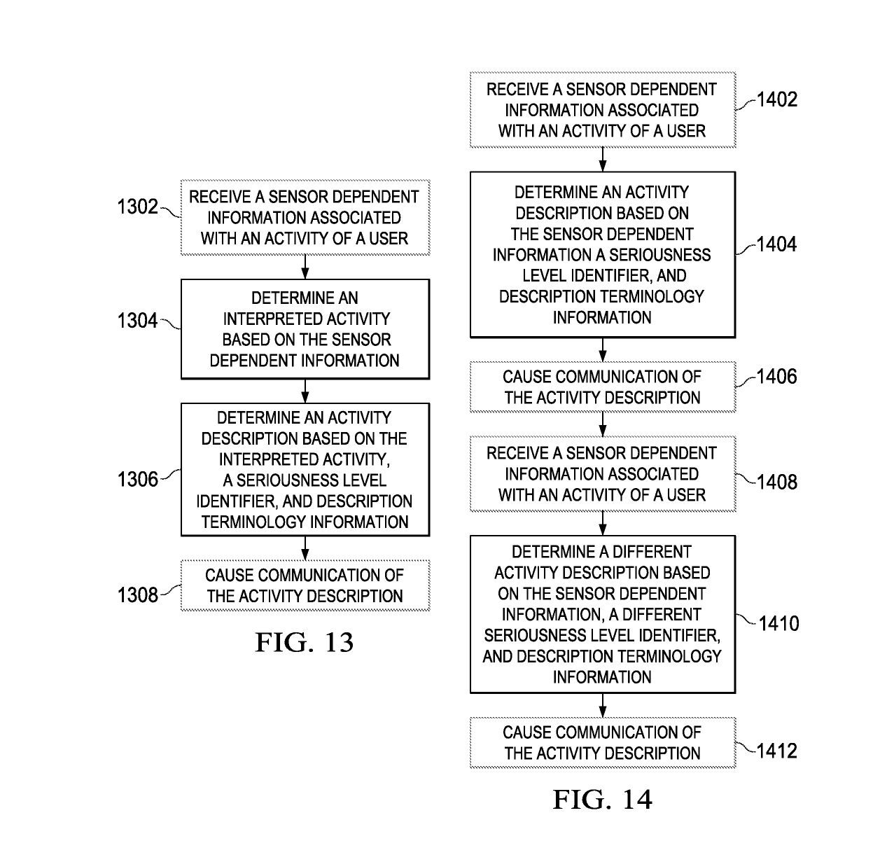

FIG. 13 is a flow diagram illustrating activities associated with determining an activity description according to at least one example embodiment. In at least one example embodiment, there is a set of operations that corresponds the activities of FIG. 13. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 13.

At block 1302, the apparatus receives a sensor dependent information associated with an activity of a user, similarly as described regarding block 402 of FIG. 4. At block 1304, the apparatus determines an interpreted activity based, at least in part, on the sensor dependent information, similarly as described regarding block 504 of FIG. 5. At block 1306, the apparatus determines an activity description based, at least in part, on the interpreted activity, a description terminology information, and a seriousness level identifier, at least part of the description terminology information being associated with a seriousness level associated with the seriousness level identifier. The description terminology information, the seriousness level identifier, the description terminology information, and the seriousness level may be similar as described regarding FIGS. 2A-2I and FIGS. 3A-3G. At block 1308, the apparatus causes communication of the activity description similarly as described regarding block 406 of FIG. 4.

FIG. 14 is a flow diagram illustrating activities associated with determining an activity description according to at least one example embodiment. In at least one example embodiment, there is a set of operations that corresponds the activities of FIG. 14. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 14.

In at least one example embodiment the same sensor dependent information may relate to different activity description in circumstances where the seriousness level identifier differs.

At block 1402, the apparatus receives a sensor dependent information associated with an activity of a user, similarly as described regarding block 402 of FIG. 4. At block 1404, the apparatus determines an activity description based, at least in part, on the sensor dependent information, a description terminology information, and a seriousness level identifier, at least part of the description terminology information being associated with a seriousness level associated with the seriousness level identifier, similarly as described regarding block 1204 of FIG. 12. At block 1406, the apparatus causes communication of the activity description similarly as described regarding block 406 of FIG. 4.

At block 1408, the apparatus receives the same sensor dependent information associated with the same activity of the user as described regarding block 1402. At block 1410, the apparatus determines a different activity description based, at least in part, on the sensor dependent information, a description terminology information, and a different seriousness level identifier, at least part of the description terminology information being associated with a seriousness level associated with the seriousness level identifier such that the different activity description differs from the activity description of block 1404. At block 1412, the apparatus causes communication of the different activity description similarly as described regarding block 406 of FIG. 4.

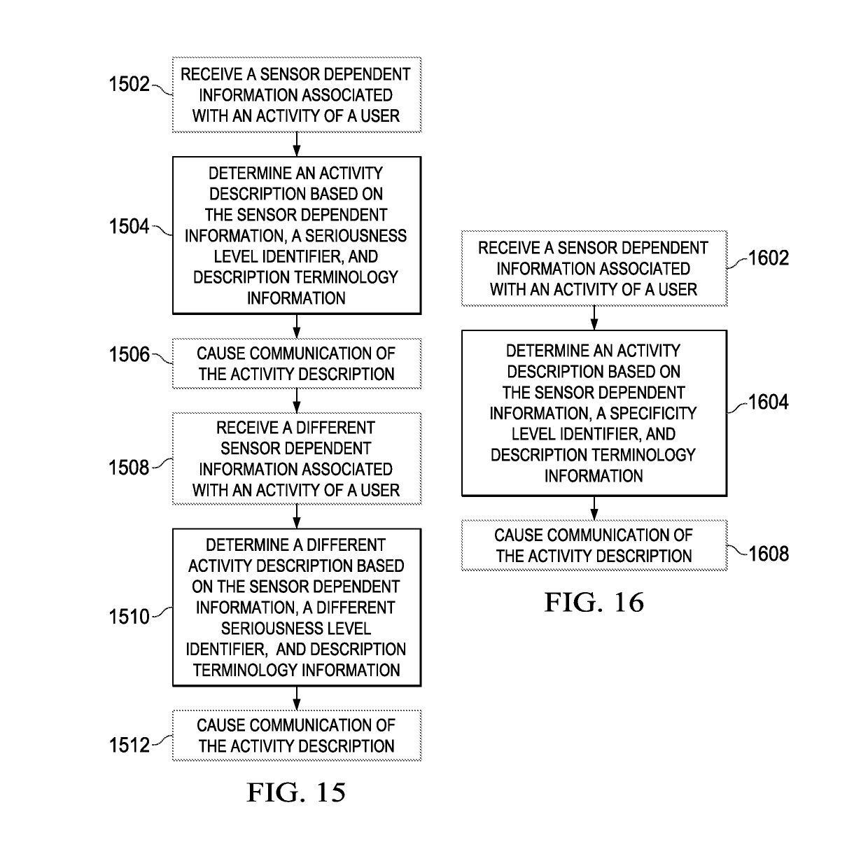

FIG. 15 is a flow diagram illustrating activities associated with determining an activity description according to at least one example embodiment. In at least one example embodiment, there is a set of operations that corresponds the activities of FIG. 15. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 15.

In at least one example embodiment the same seriousness level identifier may relate to different activity description in circumstances where the sensor dependent information differs.

At block 1502, the apparatus receives a sensor dependent information associated with an activity of a user, similarly as described regarding block 402 of FIG. 4. At block 1504, the apparatus determines an activity description based, at least in part, on the sensor dependent information, a description terminology information, and a seriousness level identifier, at least part of the description terminology information being associated with a seriousness level associated with the seriousness level identifier, similarly as described regarding block 1204 of FIG. 12. At block 1506, the apparatus causes communication of the activity description similarly as described regarding block 406 of FIG. 4.

At block 1508, the apparatus receives a different sensor dependent information than the sensor dependent information described regarding block 1502, associated with a different activity of the user than the activity of the user described regarding block 1502. At block 1510, the apparatus determines a different activity description based, at least in part, on the different sensor dependent information, the description terminology information, and the same seriousness level identifier, at least part of the description terminology information being associated with a seriousness level associated with the seriousness level identifier, such that the different activity description differs from the activity description of block 1504. At block 1512, the apparatus causes communication of the different activity description similarly as described regarding block 406 of FIG. 4.

FIG. 16 is a flow diagram illustrating activities associated with determining an activity description according to at least one example embodiment. In at least one example embodiment, there is a set of operations that corresponds the activities of FIG. 16. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 16.

At block 1602, the apparatus receives the same sensor dependent information associated with the same activity of the user as described regarding block 1402. At block 1604, the apparatus determines an activity description based, at least in part, on the sensor dependent information, a description terminology information, and a specificity level identifier, at least part of the description terminology information being associated with a specificity level associated with the specificity level identifier. The description terminology information, the specificity level identifier, the description terminology information, and the specificity level may be similar as described regarding FIGS. 2A-2I and FIGS. 3A-3G. At block 1606, the apparatus causes communication of the different activity description similarly as described regarding block 406 of FIG. 4.

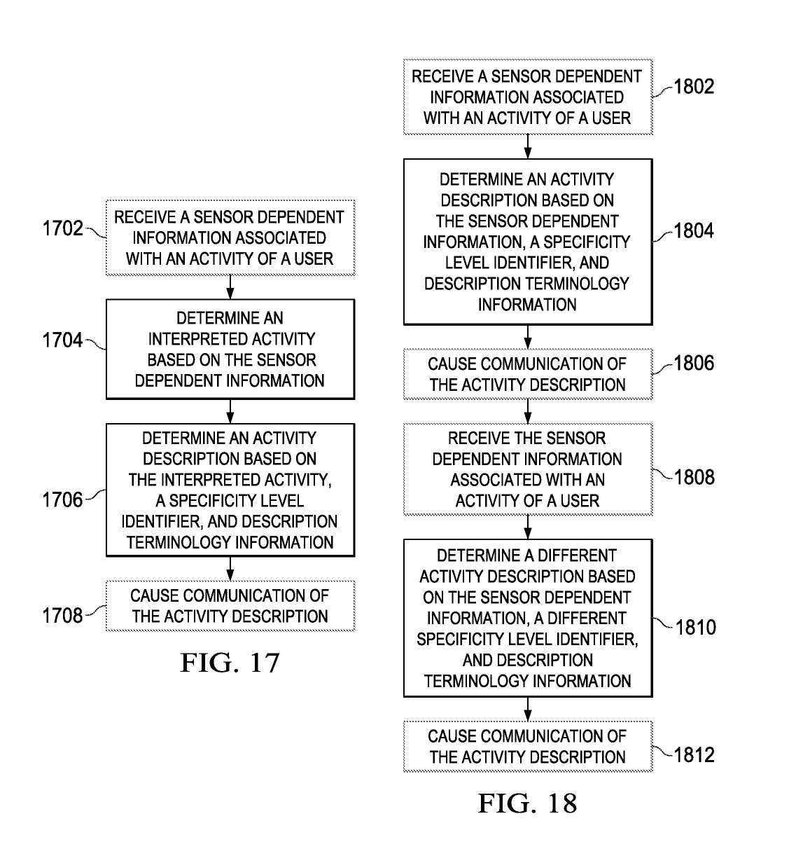

FIG. 17 is a flow diagram illustrating activities associated with determining an activity description according to at least one example embodiment. In at least one example embodiment, there is a set of operations that corresponds the activities of FIG. 17. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 17.

At block 1702, the apparatus receives a sensor dependent information associated with an activity of a user, similarly as described regarding block 402 of FIG. 4. At block 1704, the apparatus determines an interpreted activity based, at least in part, on the sensor dependent information, similarly as described regarding block 504 of FIG. 5. At block 1706, the apparatus determines an activity description based, at least in part, on the interpreted activity, a description terminology information, and a specificity level identifier, at least part of the description terminology information being associated with a specificity level associated with the specificity level identifier. The description terminology information, the specificity level identifier, the description terminology information, and the specificity level may be similar as described regarding FIGS. 2A-2I and FIGS. 3A-3G. At block 1708, the apparatus causes communication of the activity description similarly as described regarding block 406 of FIG. 4.

FIG. 18 is a flow diagram illustrating activities associated with determining an activity description according to at least one example embodiment. In at least one example embodiment, there is a set of operations that corresponds the activities of FIG. 18. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 18.

In at least one example embodiment the same sensor dependent information may relate to different activity description in circumstances where the specificity level identifier differs.

At block 1802, the apparatus receives a sensor dependent information associated with an activity of a user, similarly as described regarding block 402 of FIG. 4. At block 1804, the apparatus determines an activity description based, at least in part, on the sensor dependent information, a description terminology information, and a specificity level identifier, at least part of the description terminology information being associated with a specificity level associated with the specificity level identifier, similarly as described regarding block 1604 of FIG. 16. At block 1806, the apparatus causes communication of the different activity description similarly as described regarding block 406 of FIG. 4.

At block 1808, the apparatus receives the same sensor dependent information associated with the same activity of the user as described regarding block 1802. At block 1810, the apparatus determines a different activity description based, at least in part, on the same sensor dependent information, a description terminology information, and a different specificity level identifier, at least part of the description terminology information being associated with a specificity level associated with the specificity level identifier, such that the different activity description differs from the activity description of block 1804. At block 1812, the apparatus causes communication of the different activity description similarly as described regarding block 406 of FIG. 4.

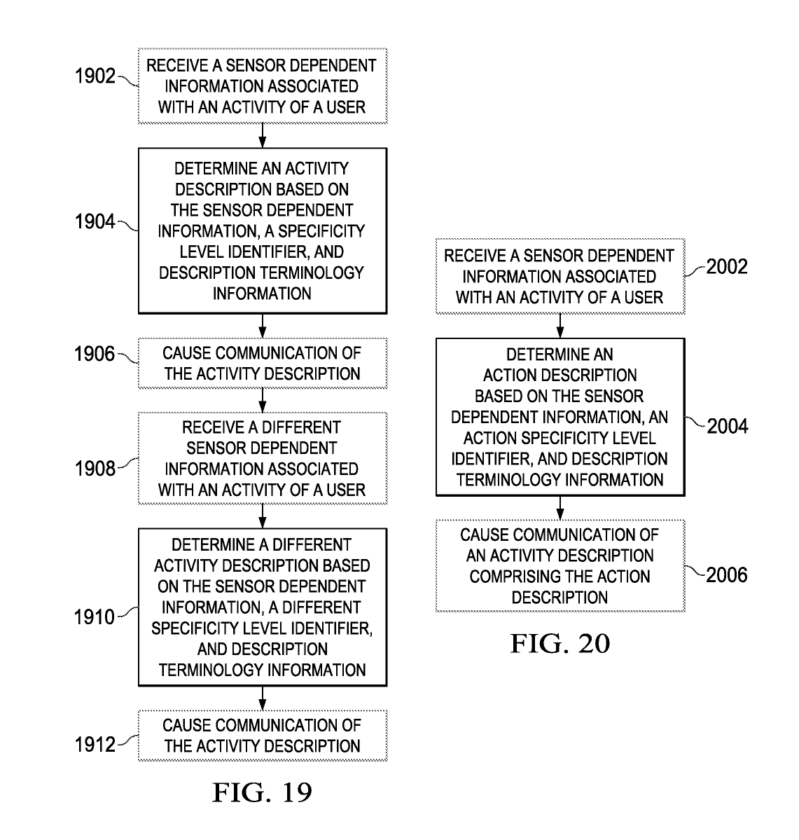

FIG. 19 is a flow diagram illustrating activities associated with determining an activity description according to at least one example embodiment. In at least one example embodiment, there is a set of operations that corresponds the activities of FIG. 19. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 19.

In at least one example embodiment the same specificity level identifier may relate to different activity description in circumstances where the sensor dependent information differs.

At block 1902, the apparatus receives a sensor dependent information associated with an activity of a user, similarly as described regarding block 402 of FIG. 4. At block 1904, the apparatus determines an activity description based, at least in part, on the sensor dependent information, a description terminology information, and a specificity level identifier, at least part of the description terminology information being associated with a specificity level associated with the specificity level identifier, similarly as described regarding block 1604 of FIG. 16. At block 1906, the apparatus causes communication of the different activity description similarly as described regarding block 406 of FIG. 4.

At block 1908, the apparatus receives a different sensor dependent information than the sensor dependent information described regarding block 1902, associated with a different activity of the user than the activity of the user described regarding block 1902. At block 1910, the apparatus determines a different activity description based, at least in part, on the different sensor dependent information, a description terminology information, and the same specificity level identifier, at least part of the description terminology information being associated with a specificity level associated with the specificity level identifier, such that the different activity description differs from the activity description of block 1904. At block 1912, the apparatus causes communication of the different activity description similarly as described regarding block 406 of FIG. 4.

FIG. 20 is a flow diagram illustrating activities associated with determining an activity description according to at least one example embodiment. In at least one example embodiment, there is a set of operations that corresponds the activities of FIG. 20. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 20.

In at least one example embodiment, a specificity level identifier comprises an action specificity level identifier. In such an example, determination of the activity description may comprise determination of an action description based, at least in part, on the sensor dependent information, the description terminology information, and the action specificity level identifier.

At block 2002, the apparatus receives a sensor dependent information associated with an activity of a user, similarly as described regarding block 402 of FIG. 4. At block 2004, the apparatus determines an action description based, at least in part, on the sensor dependent information, a description terminology information, and an action specificity level identifier, at least part of the description terminology information being associated with a specificity level associated with the action specificity level identifier. The action description, the description terminology information, the action specificity level identifier, the description terminology information, and the specificity level may be similar as described regarding FIGS. 2A-2I and FIGS. 3A-3G. At block 2006, the apparatus causes communication of an activity description that comprises the action description. The communication may be similar as described regarding FIGS. 2A-2I.

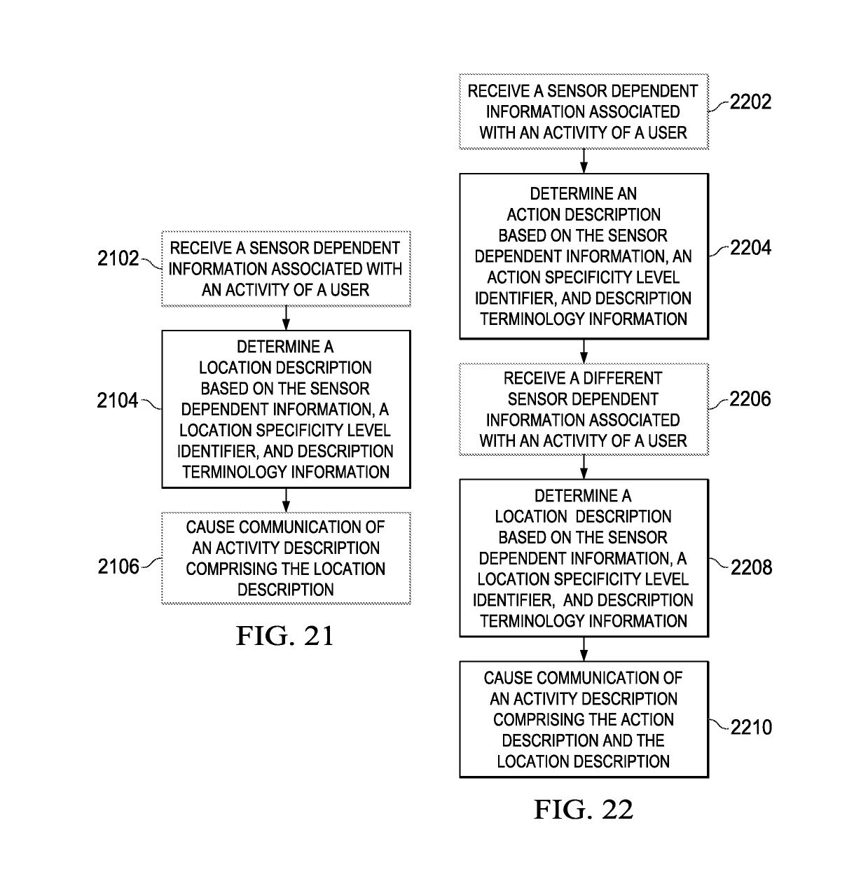

FIG. 21 is a flow diagram illustrating activities associated with determining an activity description according to at least one example embodiment. In at least one example embodiment, there is a set of operations that corresponds the activities of FIG. 21. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 21.

In at least one example embodiment, a specificity identifier comprises a location specificity level identifier. In such an example, determination of the activity description may comprise determination of a location description based, at least in part, on the sensor dependent information, the description terminology information, and the location specificity level identifier.

At block 2102, the apparatus receives a sensor dependent information associated with an activity of a user, similarly as described regarding block 402 of FIG. 4. At block 2104, the apparatus determines a location description based, at least in part, on the sensor dependent information, a description terminology information, and a location specificity level identifier, at least part of the description terminology information being associated with a specificity level associated with the location specificity level identifier. The location description, the description terminology information, the location specificity level identifier, the description terminology information, and the specificity level may be similar as described regarding FIGS. 2A-2I and FIGS. 3A-3G. At block 2106, the apparatus causes communication of an activity description that comprises the location description. The communication may be similar as described regarding FIGS. 2A-2I.

FIG. 22 is a flow diagram illustrating activities associated with determining an activity description according to at least one example embodiment. In at least one example embodiment, there is a set of operations that corresponds the activities of FIG. 22. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 22.

In at least one example embodiment, a specificity level identifier comprises an action specificity level identifier. In such an example, determination of the activity description may comprise determination of an action description based, at least in part, on the sensor dependent information, the description terminology information, and the action specificity level identifier.

In at least one example embodiment, a specificity identifier comprises a location specificity level identifier. In such an example, determination of the activity description may comprise determination of a location description based, at least in part, on the sensor dependent information, the description terminology information, and the location specificity level identifier.

In at least one example embodiment, the activity description comprises the location description and the activity description.

At block 2202, the apparatus receives a sensor dependent information associated with an activity of a user, similarly as described regarding block 402 of FIG. 4. At block 2204, the apparatus determines an action description based, at least in part, on the sensor dependent information, a description terminology information, and an action specificity level identifier, at least part of the description terminology information being associated with a specificity level associated with the action specificity level identifier, similarly as described regarding to block 2004 of FIG. 20.

At block 2206, the apparatus receives a sensor dependent information associated with an activity of a user, similarly as described regarding block 402 of FIG. 4. At block 2208, the apparatus determines a location description based, at least in part, on the sensor dependent information of block 2206, a description terminology information, and a location specificity level identifier, at least part of the description terminology information being associated with a specificity level associated with the location specificity level identifier similarly as described regarding block 2104 of FIG. 21. Even though the example of FIG. 22 comprises receiving sensor dependent information at block 2206, which is utilized at block 2208, in at least one example embodiment, the determination of block 2208 is based, at least in part, on the sensor dependent information of block 2202, and omits the receiving of sensor dependent information of block 2206. At block 2210, the apparatus causes communication of an activity description that comprises the activity description and the location description. The communication may be similar as described regarding FIGS. 2A-2I.

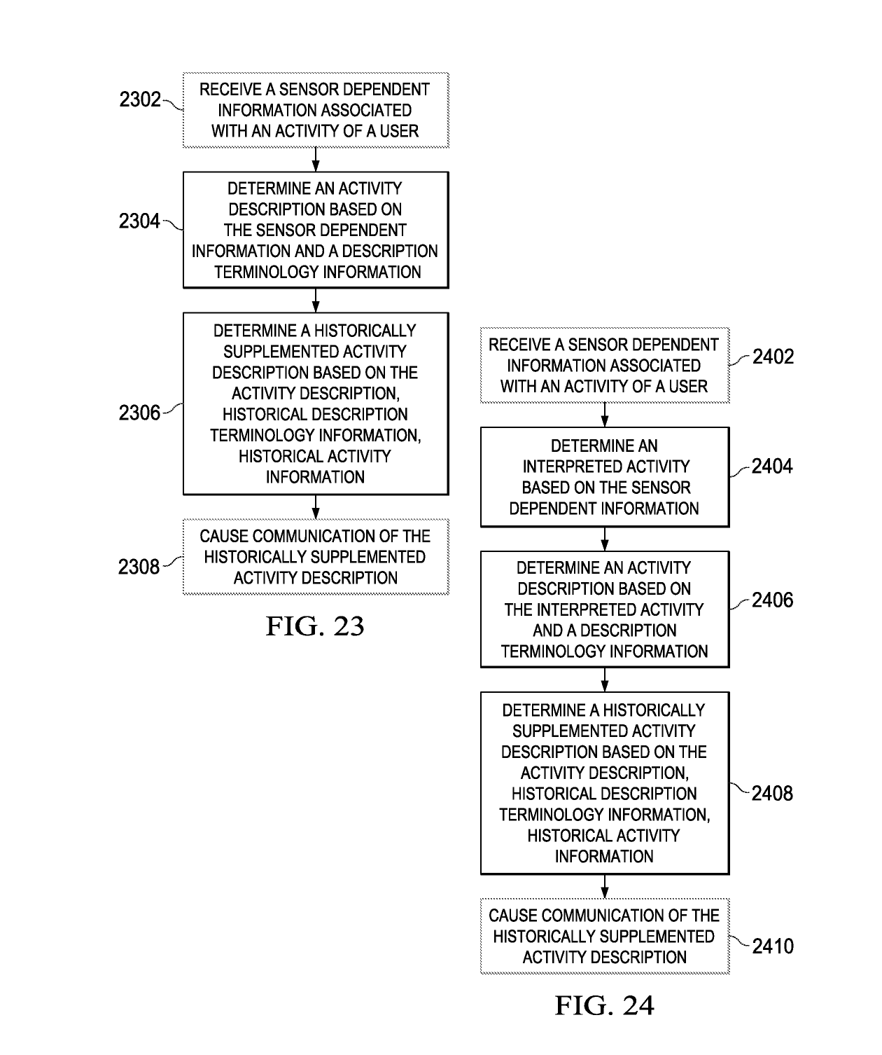

FIG. 23 is a flow diagram illustrating activities associated with determining an activity description according to at least one example embodiment. In at least one example embodiment, there is a set of operations that corresponds the activities of FIG. 23. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 23.

At block 2302, the apparatus receives a sensor dependent information associated with an activity of a user, similarly as described regarding block 402 of FIG. 4. At block 2304, the apparatus determines an activity description based, at least in part, on the sensor dependent information and a description terminology information, similarly as described regarding block 404 of FIG. 4. At block 2306, the apparatus determines a historically supplemented activity description based, at least in part, on the activity description, a historical description terminology information, historical activity information. The determination, the historically supplemented activity description, the historical terminology information, and the historical activity information may be similar as described regarding FIGS. 2A-2I and FIGS. 3A-3G. At block 2308, the apparatus causes communication of the historically supplemented activity description. The communication may be similar as described regarding FIGS. 2A-2I.

FIG. 24 is a flow diagram illustrating activities associated with determining an activity description according to at least one example embodiment. In at least one example embodiment, there is a set of operations that corresponds the activities of FIG. 24. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 24.

At block 2402, the apparatus receives a sensor dependent information associated with an activity of a user, similarly as described regarding block 402 of FIG. 4. At block 2404, the apparatus determines an interpreted activity based, at least in part, on the sensor dependent information, similarly as described regarding block 504 of FIG. 5. At block 2406, the apparatus determines an activity description based, at least in part, on the interpreted activity and a description terminology information, similarly as described regarding block 506 of FIG. 5. At block 2408, the apparatus determines a historically supplemented activity description based, at least in part, on the activity description, a historical description terminology information, historical activity information, similarly as described regarding block 2306 of FIG. 23. At block 2410, the apparatus causes communication of the historically supplemented activity description, similarly as described regarding block 2308 of FIG. 23.

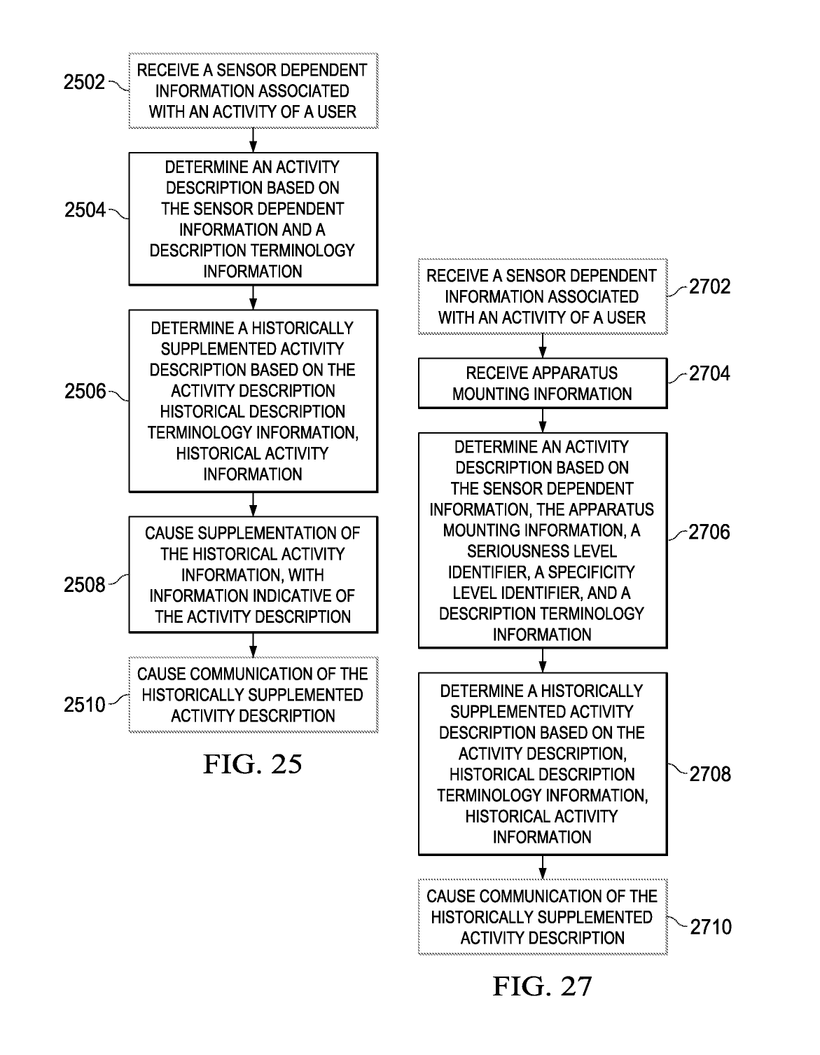

FIG. 25 is a flow diagram illustrating activities associated with determining an activity description according to at least one example embodiment. In at least one example embodiment, there is a set of operations that corresponds the activities of FIG. 25. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 25.

At block 2502, the apparatus receives a sensor dependent information associated with an activity of a user, similarly as described regarding block 402 of FIG. 4. At block 2504, the apparatus determines an activity description based, at least in part, on the sensor dependent information and a description terminology information, similarly as described regarding block 404 of FIG. 4. At block 2506, the apparatus determines a historically supplemented activity description based, at least in part, on the activity description, a historical description terminology information, historical activity information, similarly as described regarding block 2306 of FIG. 23. At block 2508, the apparatus causes supplementation of the historical activity information with information indicative of the activity description. The causation of supplementation and the information indicative of the activity description may be similar as described regarding FIGS. 2A-2I. At block 2510, the apparatus causes communication of the historically supplemented activity description, similarly as described regarding block 2308 of FIG. 23.

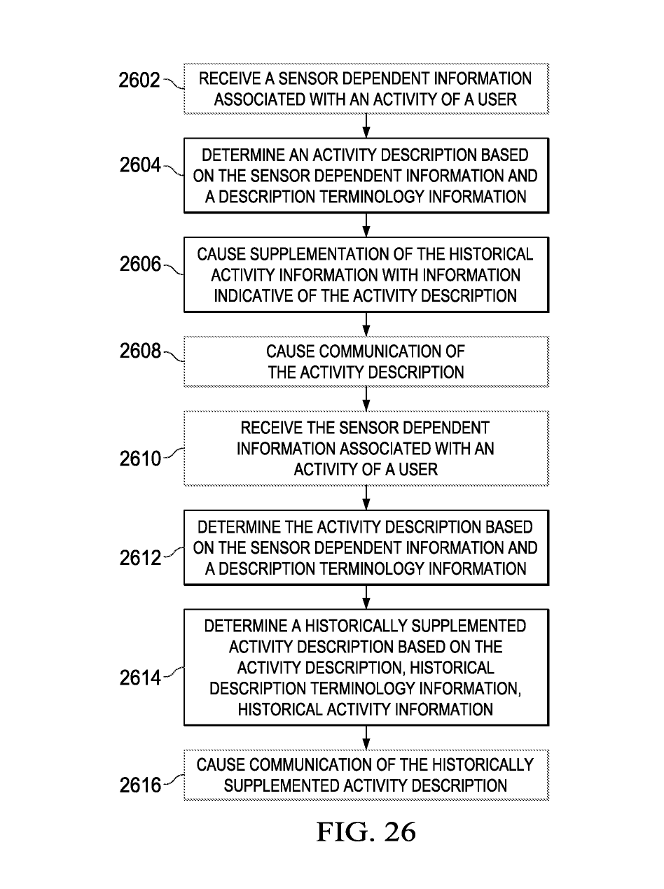

FIG. 26 is a flow diagram illustrating activities associated with determining an activity description according to at least one example embodiment. In at least one example embodiment, there is a set of operations that corresponds the activities of FIG. 26. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 26.

In at least one example embodiment, the apparatus causes supplementation of historical activity information with information indicative of a first activity description such that historically supplemented activity description for a second activity description may be based, at least in part, on the information indicative of the first activity description.

At block 2602, the apparatus receives a sensor dependent information associated with an activity of a user, similarly as described regarding block 402 of FIG. 4. At block 2604, the apparatus determines an activity description based, at least in part, on the sensor dependent information and a description terminology information, similarly as described regarding block 404 of FIG. 4. At block 2606, the apparatus causes supplementation of the historical activity information with information indicative of the activity description, similarly as described regarding block 2508 of FIG. 25. At block 2608, the apparatus causes communication of the historically supplemented activity description, similarly as described regarding block 2308 of FIG. 23.

At block 2610, the apparatus receives a sensor dependent information associated with an activity of a user, similarly as described regarding block 402 of FIG. 4. At block 2612, the apparatus determines an activity description based, at least in part, on the sensor dependent information and a description terminology information, similarly as described regarding block 404 of FIG. 4. At block 2614, the apparatus determines a historically supplemented activity description based, at least in part, on the activity description, a historical description terminology information, historical activity information, similarly as described regarding block 2306 of FIG. 23. At block 2616, the apparatus causes communication of the historically supplemented activity description, similarly as described regarding block 2308 of FIG. 23.

FIG. 27 is a flow diagram illustrating activities associated with determining an activity description according to at least one example embodiment. In at least one example embodiment, there is a set of operations that corresponds the activities of FIG. 27. An apparatus, for example electronic apparatus 10 of FIG. 1, or a portion thereof, may utilize the set of operations. The apparatus may comprise means, including, for example processor 11 of FIG. 1, for performance of such operations. In an example embodiment, an apparatus, for example electronic apparatus 10 of FIG. 1, is transformed by having memory, for example memory 12 of FIG. 1, comprising computer code configured to, working with a processor, for example processor 11 of FIG. 1, cause the apparatus to perform set of operations of FIG. 27.

At block 2702, the apparatus receives a sensor dependent information associated with an activity of a user, similarly as described regarding block 402 of FIG. 4. At block 2704, the apparatus receives apparatus mounting information, similarly as described regarding block 604 of FIG. 6. At block 2706, the apparatus determines an activity description based, at least in part, on the sensor dependent information, the apparatus mounting information, a seriousness level identifier, a specificity level identifier, and a description terminology information, that comprises at least one specificity level categorization and at least one seriousness level classification. The determination, the activity description, seriousness level identifier, a specificity level identifier, and the description terminology information may be similar as described regarding FIG. 2A-2I and FIGS. 3A-3G. At block 2708, the apparatus determines a historically supplemented activity description based, at least in part, on the activity description, a historical description terminology information, historical activity information, similarly as described regarding block 2306 of FIG. 23. At block 2710, the apparatus causes communication of the historically supplemented activity description, similarly as described regarding block 2308 of FIG. 23.

Embodiments of the invention may be implemented in software, hardware, application logic or a combination of software, hardware, and application logic. The software, application logic and/or hardware may reside on the apparatus, a separate device, or a plurality of separate devices. If desired, part of the software, application logic and/or hardware may reside on the apparatus, part of the software, application logic and/or hardware may reside on a separate device, and part of the software, application logic and/or hardware may reside on a plurality of separate devices. In an example embodiment, the application logic, software or an instruction set is maintained on any one of various conventional computer-readable media.

If desired, the different functions discussed herein may be performed in a different order and/or concurrently with each other. For example, block 2606 of FIG. 26 may be performed after block 2908. Furthermore, if desired, one or more of the above-described functions may be optional or may be combined. For example, blocks 2204 and 2208 of FIG. 22 may be optional and/or combined with block 1604 of FIG. 16.

Although various aspects of the invention are set out in the independent claims, other aspects of the invention comprise other combinations of features from the described embodiments and/or the dependent claims with the features of the independent claims, and not solely the combinations explicitly set out in the claims.

It is also noted herein that while the above describes example embodiments of the invention, these descriptions should not be viewed in a limiting sense. Rather, there are variations and modifications which may be made without departing from the scope of the present invention as defined in the appended claims.

1. An apparatus, comprising:
a processor;
memory including computer program code, the memory and the computer program code configured to, working with the processor, cause the apparatus to perform at least the following:
receiving a sensor dependent information associated with an activity of a user;
determining an activity description based, at least in part, on the sensor dependent information, a description terminology information, and a specificity level identifier, at least part of the description terminology information being associated with a specificity level associated with the specificity level identifier; and
causing communication of the activity description.

2. The apparatus of claim 1, wherein the specificity level relates to a specificity threshold.

3. The apparatus of claim 2, wherein the determination of the activity description based, at least in part, on the specificity level identifier relates to exclusion of description terminology information relating to a specificity level less than the specificity threshold.

4. The apparatus of claim 1, wherein the specificity level relates to a specificity preference.

5. The apparatus of claim 4, wherein the determination of the activity description based, at least in part, on the specificity level identifier relates to selection of description terminology information based, at least in part, on proximity to the specificity preference.

6. The apparatus of claim 1, wherein the specificity level identifier is based, at least in part on a user setting.

7. The apparatus of claim 1, wherein the specificity level identifier is based, at least in part, on recipient information.

8. The apparatus of claim 7, wherein causation of the communication of the activity description comprises causation of communication of the activity description to the recipient.

9. The apparatus of claim 1, wherein the apparatus is a mobile phone.

10. A method comprising:
receiving a sensor dependent information associated with an activity of a user;
determining an activity description based, at least in part, on the sensor dependent information, a description terminology information, and a specificity level identifier, at least part of the description terminology information being associated with a specificity level associated with the specificity level identifier; and
causing communication of the activity description.

11. The method of claim 10, wherein the specificity level relates to a specificity threshold.

12. The method of claim 11, wherein the determination of the activity description based, at least in part, on the specificity level identifier relates to exclusion of description terminology information relating to a specificity level less than the specificity threshold.

13. The method of claim 10, wherein the specificity level relates to a specificity preference.

14. The method of claim 13, wherein the determination of the activity description based, at least in part, on the specificity level identifier relates to selection of description terminology information based, at least in part, on proximity to the specificity preference.

15. The method of claim 10, wherein the specificity level identifier is based, at least in part on a user setting.

16. The method of claim 10, wherein the specificity level identifier is based, at least in part, on recipient information.

17. The method of claim 16, wherein causation of the communication of the activity description comprises causation of communication of the activity description to the recipient.

18. A non-transitory computer-readable medium encoded with instructions that, when executed by a computer, perform:
receiving a sensor dependent information associated with an activity of a user;
determining an activity description based, at least in part, on the sensor dependent information, a description terminology information, and a specificity level identifier, at least part of the description terminology information being associated with a specificity level associated with the specificity level identifier; and
causing communication of the activity description.

19. The medium of claim 18, wherein the specificity level relates to a specificity threshold.

20. The medium of claim 19, wherein the determination of the activity description based, at least in part, on the specificity level identifier relates to exclusion of description terminology information relating to a specificity level less than the specificity threshold.

21-25. (canceled)
